(19) United States
(12) Patent Application Publication
(10) Pub. No.: US 2012/0324746 A1
(43) Pub. Date: Dec. 27, 2012

(54) DUAL-GLOBE APPARATUS

(76) Inventors: Andrew F. Hanson, Geneva, IL (US); Robert B. Hudson, Naperville, IL (US); Walter J. Sedlacek, West Chicago, IL (US); Sajid Patel, Arlington Heights, IL (US)

(21) Appl. No.: 13/337,284

(22) Filed: Dec. 26, 2011

Related U.S. Application Data
(63) Continuation-in-part of application No. 12/500,028, filed on Jul. 9, 2009, now Pat. No. 8,109,005.

(51) Int. Cl. G01C 9/20

(52) U.S. Cl. 33/377

(57) ABSTRACT

The dual-globe apparatus utilizes at least one indicator on a tool. The indicator comprises an outer vessel buoyantly supported within an inner vessel. In one embodiment, the outer vessel and inner vessel comprise spheres. In another embodiment, the outer vessel and inner vessel comprise spherical segments.

### CROSS REFERENCE TO RELATED APPLICATIONS

This application claims priority to U.S. Provisional Application Ser. No. 61/079,824 filed on Jul. 11, 2008 and is a continuation-in-part application of U.S. application Ser. No. 12/500,028, filed on Jul. 9, 2009.

### TECHNICAL FIELD OF THE INVENTION

This invention relates generally to construction levels and similar leveling devices, and more particularly to levels that are easier to read. can measure angles and pitches, and indicate and/or measure the level of a plane along at least two directions, using a single tool. This invention also relates generally to tools and similar devices, and more particularly to tools having an indicator that can measure angles and pitches and indicate and/or measure the level or plumb of the tool along at least two directions.

### BACKGROUND OF THE INVENTION

Levels are used extensively within the construction industry. They enable a determination of whether a given line or surface is horizontal or vertical when the level is positioned on the line or surface. Some levels also enable a determination of the angular inclination and/or pitch (i.e., rise and run) of a given line or surface from the horizontal or vertical.

Various types of levels are known within the industry. The most common type of level,is the bubble level, also known as the “spirit level.” This type of level typically comprises an elongated body defining upper and lower longitudinal surfaces, a pair of opposing, outer ends, and has at least one liquid-filled tube or vial mounted thereon. The liquid-filled tube or vial contains a gas bubble therein while the tube or vial itself is centrally marked with one or more paired lines that define a center widow. The tube or vial is mounted to the elongated body in a generally horizontal or vertical position such that the gas bubble moves to within the center window (i.e., between the pair of lines) when the level is positioned along a respective horizontal or vertical line or surface.

For a determining whether a given line or surface is approximately horizontal (i.e., level), the liquid-filled tube is mounted to the lengthwise, elongated body, there-along or parallel there-with, such that the tube is generally horizontal and the gas bubble falls within the center window when the upper or lower edge of the body of the level is placed along a horizontal line or surface. For determining whether a given line or surface is approximately vertical (i.e., plumb), the liquid-filled tube is mounted to the lengthwise, elongated body, perpendicular thereto, such that the tube is generally horizontal and the gas bubble falls within the center window when the upper or lower edge of the body of the level is placed along a vertical line or surface. Thus, this type of level is generally limited to determining whether a given line or surface is approximately horizontal or vertical.

A variation of the bubble or spirit level has a liquid-filled tube or vial that is manually rotatable in relation to the elongated body such that the tube is generally horizontal and the gas bubble is maintained within the center window (i.e., between the paired lines) when the upper or lower longitudinal surface of the body of the level is placed along a line or surface having a predetermined angle from the vertical or horizontal. Such levels generally include markings or indicia thereon that indicate the degree of angle of inclination and/or pitch (i.e., rise and run) of such a line or surface from the horizontal or vertical when the gas bubble is within the window.

While bubble or spirit levels are simple and inexpensive, they suffer from disadvantages because their accuracy is subject to error. The position of the gas bubble within the window (i.e., between the pair of lines) is typically determined by comparing the alignment of the bubble's outer periphery with the tube's paired lines defining the window. When the upper or lower edge of the body of the level is placed along an ideally horizontal or vertical line or surface, the outer periphery of the bubble should fall equally and/or tangentially between the paired lines of the window. The accuracy errors may be attributed to the fact that a determination of the position of the bubble's periphery in relation to the paired lines of the central window is merely a visual approximation. Such an approximation may be negatively affected by physical factors, to include capillary effects existing between the liquid tube's inner surface, and temperature and pressure conditions which may cause an increase or decrease in size and/or volume of the gas bubble within the liquid.

Thus, other types of levels have been devised that do not utilize gas bubbles within liquid-filled tubes. Such levels, generally referred to as pendulum levels, accordingly utilize pendulum indicators mounted to the elongated body to determine whether a given line or surface is horizontal or vertical when an upper or lower longitudinal surface of the body of the level is placed there-along. The pendulum, comprising a weighted body suspended from a fixed point so as to swing freely under the influence of gravity, and typically including an indicator located diametrically opposite of the weighted body, generally will always maintain a vertical orientation. These pendulum levels generally include markings or indicia thereon, referenced from the vertical orientation of the pendulum, such that the degree of angle of inclination and/or pitch (i.e., rise and run) of a given line or surface from the horizontal or vertical may be readily determined.

For determining whether a given line or surface is approximately horizontal (i.e., level), the pendulum will generally be oriented perpendicular to the lengthwise, elongated body of the level when an edge of the level is placed along a horizontal line or surface. For determining whether a given line or surface is approximately vertical (i.e., plumb), the pendulum will generally be oriented parallel to the lengthwise, elongated body of the level when an edge of the level is placed along a vertical line or surface. A variation of the pendulum level includes markings or indicia thereon, referenced from the vertical orientation of the pendulum, such that the degree of angle of inclination and/or pitch (i.e., rise and run) of a given line or surface from the horizontal or vertical may be readily determined.

Like bubble or spirit levels, pendulum levels suffer from disadvantages. One such disadvantage includes a limitation of a use of the device along a single plane. Because a pendulum vertically swings from an axial pivot, movement of the pendulum is thus limited to a vertical plane of rotation about a horizontal, rotational axis. Thus, for a pendulum level to indicate whether a given line or surface is vertical or horizontal, the vertical plane of rotation of the pendulum must be maintained such that the pendulum may swing freely to its vertical, indicative orientation. Thus, where a pendulum is axially mounted to the elongated body of a level, the use of the level is limited this vertical plane or rotation. In other words, the level is rendered useless or inaccurate if it is “turned on its side” or oriented in any position outside the pendulum's vertical plane of rotation.

Another disadvantage of pendulum levels includes the fact that a swinging pendulum may oscillate (i.e., swing to and fro) before coming to rest to indicate its ultimate, vertical orientation. Although a frictional or spring-biased damper may be utilized on the axial pivot of the pendulum to minimize its oscillatory, swinging movement, such a damper may jeopardize the accuracy of the pendulum by not allowing it to reach its ultimate, vertical and indicative orientation.

Yet other types of levels have been devised with a body utilizing upwardly-facing spherical or semi-spherical liquid-filled “bulls-eye” vials having a gas bubble therein. The gas bubble, floating against the underside of the spherical or semi-spherical vial, may center itself at the intersection of two intersecting axes or windows and/or within one or more concentric circles located on the vial, thus allowing the upwardly-facing level to provide level information relative to a planar surface. However, in addition to suffering from the same disadvantages inherent in spirit levels relating to accuracy and the negative effect of physical factors, bulls-eye levels also suffer from disadvantages relating to versatility. For example, bulls-eye levels are difficult to use in relation to indicating and/or measuring level and plumb values along a single direction.

Similarly, tools having level or bubble indicators are also used extensively within the construction industry. They enable a determination of whether a given tool is level or plumb in relation to a given line or surface.

In relation to the liquid-filled tube or vial, containing a gas bubble therein, discussed in the foregoing paragraphs, the tube or vial is mounted to a given tool, for example, a drill, such that the gas bubble moves to within the center window (i.e., between the pair of lines) when the drill is positioned in relation to a given line or surface. Nonetheless, while bubble or spirit levels are simple and inexpensive, again, they suffer from disadvantages because their accuracy is subject to error. The position of the gas bubble within the window (i.e., between the pair of lines) is typically determined by comparing the alignment of the bubble's outer periphery with the tube's paired lines defining the window. When the upper or lower edge of the body of the level is placed along an ideally horizontal or vertical line or surface, the outer periphery of the bubble should fall equally and/or tangentially between the paired lines of the window. The accuracy errors may be attributed to the fact that a determination of the position of the bubble's periphery in relation to the paired lines of the central window is merely a visual approximation. Such an approximation may be negatively affected by physical factors, to include capillary effects existing between the liquid tube's inner surface, and temperature and pressure conditions which may cause an increase or decrease in size and/or volume of the gas bubble within the liquid.

In relation to the upwardly-facing spherical or semi-spherical liquid-filled “bulls-eye” vials, having a gas bubble therein, discussed in the foregoing paragraphs, the vial is mounted to an end of a given tool, for example, a drill, such that the gas bubble, floating against the underside of the spherical or semi-spherical vial, may center itself at the intersection of two intersecting axes or windows and/or within one or more concentric circles located on the vial, thus allowing the upwardly-facing vial of the tool level to provide information relative to the plumb of the tool in relation to a given line or surface. However, in addition to suffering from the same disadvantages inherent in spirit levels relating to accuracy and the negative effect of physical factors, bulls-eye levels also suffer from disadvantages relating to versatility. For example, bulls-eye levels are difficult to use in relation to indicating and/or measuring level and plumb values along a single direction.

Furthermore, in relation to the use of various foregoing bubble vials indicators in relation to tools, such indicators do not enable a determination of the angular inclination and/or pitch (i.e., rise and run) of the tool in relation to a given line or surface. The present invention thus remedies the foregoing disadvantages while presenting additional advantages as well.

### SUMMARY OF THE INVENTION

The level comprises at least one indicator located on a body. The body defines front and rear faces, a pair of opposing ends, and at least one longitudinal surface, preferably lower and upper longitudinal surfaces, with the body being elongated or non-elongated as well. An outer vessel of the at least one indicator is located at least partially between the front and rear faces of the body to define front and rear outer vessel faces. In the preferred embodiments, the outer vessel defines a spherical outer globe of the at least one indicator located at least partially between the front and rear faces of the body to define front and rear outer globe faces. In other embodiments, the outer vessel may, define other geometric shapes defining front and rear faces as understood in the art. The front and rear faces of the body optionally include a bezel's front and rear faces, with the bezel securing the outer globe at least partially between the front and rear faces of the body.

An inner vessel of the at least one indicator is located within the outer vessel. The inner vessel, viewable through the outer vessel and defining an equator around its outer periphery, is buoyantly biased to maintain the equator in a substantially horizontal position. The inner vessel may be buoyantly supported within the outer vessel via a liquid or via a mechanical means. The equator is in operable registry relation with a first indicia to indicate a position of the at least one longitudinal surface of the body in relation to a surface or line in question located adjacent to the at least one longitudinal surface. Embodiments of the inner vessel may define various geometric shapes understood in the art capable of maintaining a buoyant position. However, in preferred embodiments, the inner vessel comprises a substantially spherical inner globe, with the inner globe located within the outer globe and supported by liquid located within the outer globe. The inner globe, viewable through both the liquid and the outer globe and again defining an equator around its outer periphery, is buoyantly biased within the liquid to maintain the equator in a substantially horizontal position. In other embodiments, the substantially spherical inner globe is located within the outer globe and is supported by mechanical means located there-between, with the inner globe again viewable through the outer globe, defining an equator around its outer periphery, and buoyantly biased to maintain the equator in a substantially horizontal position.

In one embodiment, the lower and upper longitudinal surfaces and front and rear faces of the level's body define an arcuate, “I” shaped cross-section. However, in other embodiments, the front and rear faces define a body having a rectangular cross section as well. It is yet further understood that, regardless, of the cross-sectional shape of the level's body, the outer vessel (i.e., globe), in being located at least partially between the front and rear faces of the body, may be located fully between the front and rear faces as well. The lower and upper portions of the respective front and rear faces each preferably define planar surfaces adapted for contact with a given planar surface in question. The lower and upper longitudinal surfaces of the at least one longitudinal surface each preferably define planar surfaces oriented perpendicular to the front and rear faces of the body and adapted for contact with a given planar surface in question to be referenced by the level.

A lengthwise groove may be defined in either, or both of the lower and upper longitudinal surfaces, with the groove is adapted for contact with the edge of a given planar surface in question and/or the outer surface of a round member, such as a pipe, to be referenced by the level. A lengthwise cutout may also be defined in either or both of the lower and upper longitudinal surfaces to allow a user of the level to more easily view the indicator. Optional end caps may be located at the body's outer ends as well to protect the ends of the level's body from impact damage if the level is inadvertently dropped by the user. An adjustment mechanism may also be located on the level to allow a manufacturer to rotate the indicator about approximate horizontal and vertical axes to adjust for manufacturing tolerances and ensure that the indicator is true in relation to the level's body.

The inner globe includes the equator, defined around its outer periphery, that is in operable registry relation with the first indicia to indicate a position of the at least one longitudinal surface of the body in relation to the adjacent surface or line in question. In one embodiment, the first indicia comprises X and Y axes intersecting one another at 90 degrees, with the outer ends of the axes located on the front face of the level about the outer vessel (i.e., globe) of the indicator to define four quadrants. Assuming a horizontal orientation of the body, the lines of the X and Y axes define horizontal and vertical reference lines, with the horizontal X axis lying parallel to the lower and upper longitudinal surfaces of body and the vertical Y axis lying perpendicular to the X axis and the body's lower and upper longitudinal surfaces. The quadrants of the first indicia discussed above may optionally include markings indicating indexed angle and/or pitch.values, respectively.

The first indicia may additionally or alternatively include a horizontal circumferal equator and a vertical circumferal line preferably located on the front face of the outer globe that intersect one another at 90 degrees. The circumferal equator and vertical circumferal lines define X and Y axes on the front face of the outer globe that, in turn, define horizontal and vertical reference lines. In defining horizontal and vertical reference lines, the outer globe's horizontal X axis again lies parallel to the lower and upper longitudinal surfaces of the body while its vertical Y axis again lies perpendicular to the X axis and the body's lower and upper longitudinal surfaces. If used in addition to the X and Y axes located on the front face of the body, the X and Y axes of the outer globe are respectively aligned with the outer ends of the X and Y located about the globe.

With regard to the operable registry relation of the inner globe's equator 160 with the first indicia, the equator, buoyantly biased in the horizontal position, will lie in registry with the outer ends of the X axis located on the front face of the body about the outer globe and/or the X axis located on the front face of the outer globe when the at least one longitudinal surface of the level is positioned adjacent to the horizontal surface or line in question. The equator, again buoyantly biased in the horizontal position, will similarly lie in registry with the outer ends of the Y axis located on the front face of the body about the outer globe and/or the Y axis located on the front face of the outer globe when the at least one longitudinal surface is positioned along a vertical surface or line in question. Of course, if a given line or surface in question deviates from the horizontal or vertical, the equator will lie in registry with the optional indexed angle and/or pitch values of the quadrants to indicate the degree and/or pitch of the deviation.

The inner globe also includes a polar marking concentrically centered within the outer periphery of the upper hemisphere defined by the equator, with the marking in operable registry relation with a second indicia to indicate a position of the front face of the body in relation to a surface in question located adjacent to the front face. Although the polar marking may comprises a solid circle, the polar marking may comprise a cross-hair or other marking as well. The second indicia preferably comprises a circle and/or cross-hair concentrically located on the rear face of the outer globe and may optionally include index lines or gradations to allow a user to determine a percent of grade or elevation. In other embodiments of the invention, the polar marking of the inner globe is in operable registry relation with the first indicia (i.e., the X and Y axes located on the front face of the outer globe) to indicate a position of the rear face of the body in relation to a surface in question located adjacent to the rear face.

Various embodiments of the at least one indicator may also be located on a tool as well. Such tools may include a screwdriver, chisel, jig saw, circular saw, miter saw, wrench, drill, shovel, knife, marking tool, machine tool or any other tool that would benefit from having the indicator operably associated therewith. in one embodiment, the at least one indicator of the tool comprises an outer vessel defining a spherical outer globe. In other embodiments, the outer vessel may define a cube, truncated cube or rhombicuboctahedron defining front and rear cube faces, a spherical or arcuate segment, or other geometric shapes understood in the art. Any of the foregoing geometric shapes may optionally have outwardly-acuate sides or faces as well.

The tool optionally includes a bezel that divides the outer vessel into front and rear faces. However, it is understood that one or more additional bezels, or no bezel, may be utilized as well. An inner vessel of the at least one indicator is located within the outer vessel. The inner vessel, viewable through the outer vessel and preferably defining an equator around its outer periphery, is buoyantly biased to maintain the equator in a substantially horizontal position. The equator is in operable registry relation with a first indicia located on the outer vessel and/or bezel to indicate a position of the tool in relation to a surface or line in question. Embodiments of the inner vessel may define an ovular sphere, spherical cone, any variation of dipyramid, bipyramid or deltahedron, a spherical or arcuate segment, or any other geometric form understood in the art capable of maintaining a buoyant position. However, in a preferred embodiment, the inner vessel of the one indicator comprises a substantially spherical inner globe.

In alternate embodiments of the at least one indicator located on the tool, the outer vessel defines a hollow spherical segment. An inner vessel is located within the outer vessel, is viewable through the outer vessel and also defines a spherical segment. It is understood, however, that while the outer vessel of this embodiment preferably comprises a spherical segment, the outer vessel may also comprise a full sphere with the inner vessel comprising the spherical segment. The inner spherical segment, further defines an outer circumference that is in operable registry relation with a first indicia of the outer vessel and/or bezel to indicate a position of the tool in relation to a surface or line in question. The inner spherical segment is buoyantly biased within the liquid to maintain the outer circumference in a substantially horizontal position. The configuration of the inner and outer spherical segments provide the additional advantage of allowing the indicator to be located on smaller tools without sacrificing either the accuracy of the indicator or reducing the indicator's and/or related indicia's readability. In each of the indicators recited above, the indicators may be optionally oriented to a predetermined measurement or preset angle such that any deviation from the preset angle or measurement reflects an angle amount out from that preset angle. In orienting or adjusting the at least one indicator to the preset or predetermined position, the indicator may be movably attached to the tool and/or body via a resistance-fit or similar adjustment mechanism. Furthermore, the at least one indicator may be fixably or removably located on the tool.

### BRIEF DESCRIPTION OF THE DRAWINGS

FIG. 1 is a perspective view of the front of one embodiment of the level;

FIG. 2 is an elevation view of the front of the level of FIG. 1;

FIG. 3 is a plan view of rear of one embodiment of the level;

FIG. 4 is section view of the one embodiment of the body of the level of FIG. 1;

FIG. 5 is perspective assembly view of an end and end cap of the level;

FIG. 6 is a perspective exploded view of one embodiment of the bezel, outer globe, flanges and body of the level;

FIG. 7 is a perspective exploded view of another embodiment of the bezel, outer globe, flanges and body of the level;

FIG. 8 is a sectional view of one embodiment of the inner and outer globes of FIG. 1;

FIG. 9 is a perspective exploded view of another embodiment of the inner and outer globes of FIG. 1;

FIG. 10 is a close-up perspective view of the front face and equator of the level;

FIG. 11 is a close-up perspective view of the front face, equator and a first indicia of the level;

FIG. 12 is a close-up perspective view of the front face, equator and an alternate first indicia of the level;

FIG. 13 is a close-up perspective view of the front face, equator and another alternate first indicia of the level;

FIG. 14 is a close-up plan view of the rear face, polar marking and second indicia of the level;

FIG. 15 is a close-up plan view of the front face, polar marking and first indicia of the level;

FIG. 16 is a front elevation view of one embodiment of the level verifying a horizontal line or surface in question;

FIG. 17 is a front elevation view of one embodiment the level verifying a vertical line or surface in question;

FIG. 18 is a front elevation view of one embodiment of the level verifying a deviation of a line or surface in question from the horizontal;

FIG. 19 is a front elevation view of one embodiment of the level verifying a deviation of a line or surface in question from the vertical;

FIG. 20 is a plan view of the rear of one embodiment of the level verifying a planar surface in question along at least two directions;

FIG. 21 is a plan view of the front of one embodiment of the level verifying a planar surface in question along at least two directions;

FIG. 22 is a perspective view of one embodiment of a tool having the indicator located thereon;

FIG. 23 is a perspective view of the tool of FIG. 22 having an alternate embodiment of the indicator located thereon;

FIG. 24 is a section view of the indicator of FIG. 23; and

FIG. 25 is a plan view of the end of the tool and indicator of FIG. 23.

### DESCRIPTION OF THE EMBODIMENTS

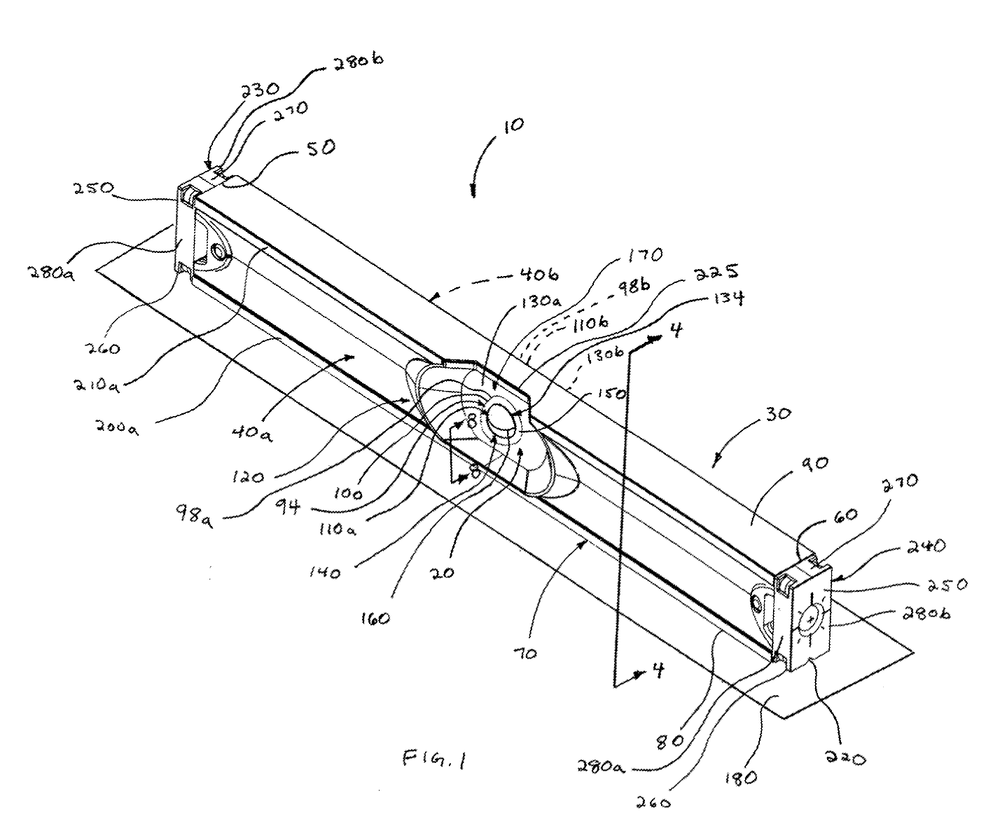

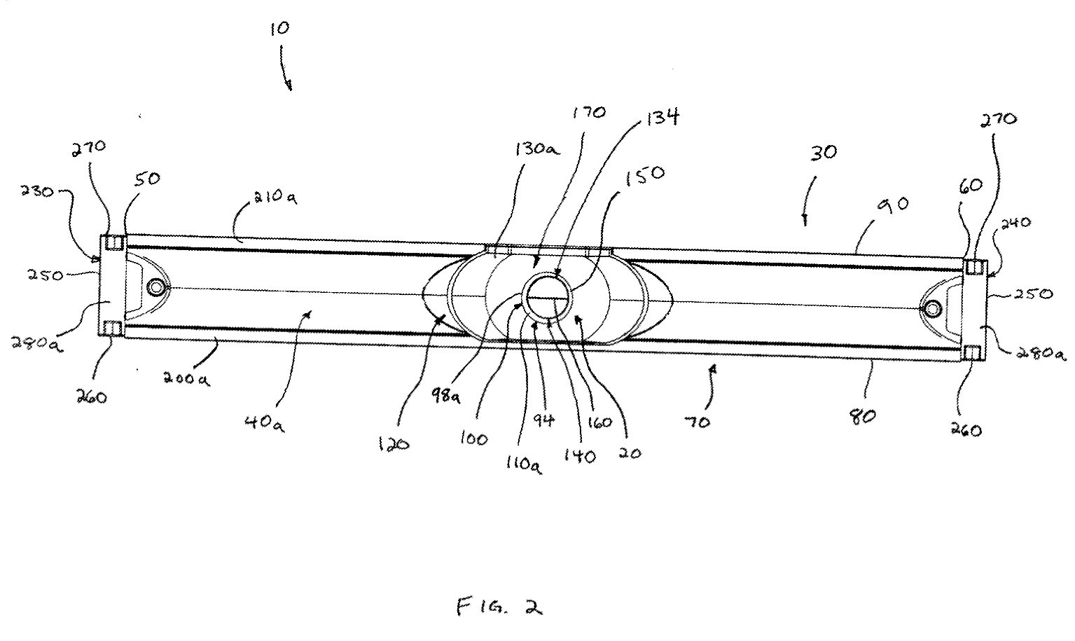

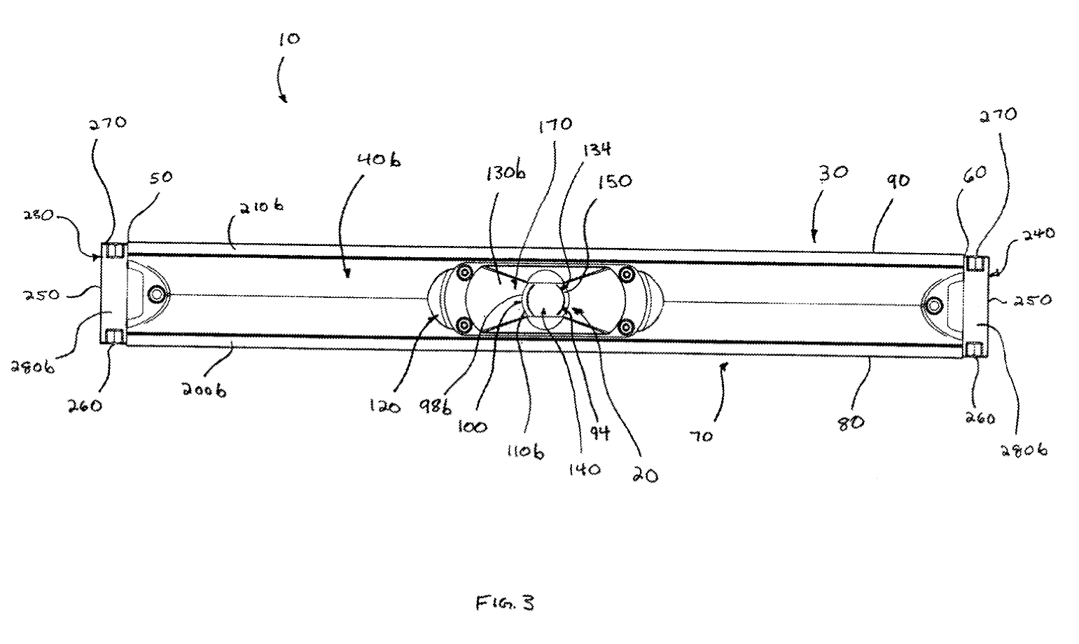

Referring initially to FIGS. 1-3, the level 10 comprises at least one indicator 20 located on a body 30. The body defines front and rear faces 40a and 40b, a pair of opposing ends 50 and 60, and at least one longitudinal surface 70, preferably lower and upper longitudinal surfaces 80 and 90. Although the figures illustrate the body 30 as being elongated, it is understood that the body may.be non-elongated as well. For example, the at least one longitudinal surface 70 may have a length dimension equal to or less than the height dimension defined by the opposing ends. An outer vessel 94 of the at least one indicator is located at least partially between the front and rear faces of the body to define front and rear outer vessel faces 98a and 98b. In the preferred embodiments illustrated herein, the outer vessel defines a spherical outer globe 100 of the at least one indicator located at least partially between the front and rear faces of the body to define front and rear outer globe faces 110a and 110b. In other embodiments, the outer vessel may define a cube, truncated cube or rhombicuboctahedron defining front and rear cube faces, or other geometric shapes defining front and rear faces as understood in the art. Any of the foregoing geometric shapes may optionally have outwardly-acuate sides or faces as well. The front and rear faces of the body optionally include a bezel's 120 front and rear faces 130a and 130b, with the bezel securing the outer vessel (i.e., outer globe) at least partially between the front and rear faces of the body.

An inner vessel 134 of the at least one indicator is located within the outer vessel 94. The inner vessel, viewable through the outer vessel and defining an equator 160 around its outer periphery, is buoyantly biased to maintain the equator in a substantially horizontal position. The inner vessel may be buoyantly supported within the outer vessel via a liquid or via a mechanical means, to be further discussed. The equator is in operable registry relation with a first indicia 170 to indicate a position of the at least one longitudinal surface of the body in relation to a surface or line in question 180 located adjacent to the at least one longitudinal surface. Embodiments of the inner vessel 134 may define an ovular sphere, spherical cone, any variation of dipyramid, bipyramid or deltahedron, or any other geometric form understood in the art capable of maintaining a buoyant position. However, in preferred embodiments, the inner vessel 134 of the at least one indicator comprises a substantially spherical inner globe 140, with the inner globe located within the outer globe 140 and supported by liquid 150 located within the outer globe. The inner globe, viewable through both the liquid and the outer globe and again defining an equator 160 around its outer periphery, is buoyantly biased within the liquid to maintain the equator in a substantially horizontal position. In other embodiments, the substantially spherical inner globe 140 is located within the outer globe and is supported by mechanical means located there-between, with the inner globe again viewable through the outer globe, defining an equator 160 around its outer periphery, and buoyantly biased to maintain the equator in a substantially horizontal position. For example, the mechanical means may comprise one or more ball bearings located between the inner and outer globes to buoyantly support the inner globe therein. In yet further embodiments, the inner globe 140 is located within the outer vessel, 94 defining a cube or other geometric shape and is again supported by liquid 150 located within the outer vessel. The inner globe, viewable through both the liquid and the outer vessel and again defining an equator 160 around its outer periphery, is buoyantly biased within the liquid to maintain the equator in a substantially horizontal position.

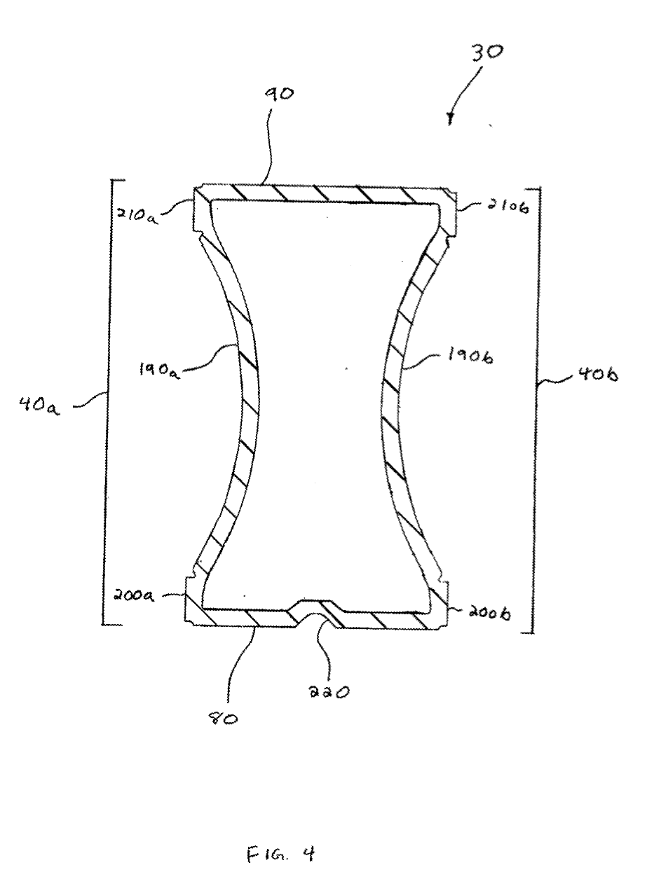

As illustrated in FIG. 4, the lower and upper longitudinal surfaces 80 and 90 and front and rear faces 40a and 40b of the level's body 30 define an arcuate, “I” shaped cross-section, with the faces comprising recessed, inwardly-arcuate center portions 190a and 190b located between lower and upper outer portions 200a, 210a and 200b, 210b, respectively, defined by edges of the lower and upper longitudinal surfaces. Although the center portions of the front and rear faces each define inwardly-arcuate recessed portions located between the lower and upper outer portions to define the arcuate “I” shaped cross-section of the body, it is understood that the center portions may be non-arcuate recessed portions to define a non-arcuate “I” shaped cross-section as well. It is further understood that the center portions may be non-recessed and co-planar with the lower and upper outer portions such that the front and rear faces define a body having a rectangular cross section as well. It is yet further understood that, regardless of the cross-sectional shape of the level's body, the outer vessel (i.e., globe), in being located at least partially between the front and rear faces of the body, may be located fully between the front and rear faces as well.

The lower and upper portions 200a, 210a and 200b, 210b of the respective front and rear faces 40a and 40b each preferably define planar surfaces, with the lower and upper portions common to a given face lying co-planar with one another. The co-planar lower and upper portions of a given face are thus adapted for contact with a given planar surface in question, with the co-planar surfaces of a front or rear face located adjacent to the given surface in question. The lower and upper longitudinal surfaces 80 and 90 of the at least one longitudinal surface 70 each preferably define planar surfaces oriented perpendicular to the front and rear faces 40a and 40b of the body 30, with the surfaces perpendicular to. the their respective edges defining the lower and upper portions of the front and rear faces. The lower and upper longitudinal surfaces are each adapted for contact with a given planar surface in question to be referenced by the level, with the planar surface of an upper or lower surface located adjacent to the given surface in question.

A lengthwise groove 220 may be defined in either or both of the lower and upper longitudinal surfaces 80 and 90 of the at least one longitudinal surface 70, with at least FIGS. 1 and 4 illustrating the groove defined in the lower longitudinal surface of the body, by example. The lengthwise groove is adapted for contact with the edge of a given planar surface in question and/or the outer surface of a round member, stich as a pipe, to be referenced by the level. A lengthwise cutout 225 may also be defined in either or both of the lower and upper longitudinal surfaces, centrally disposed below or above, respectively, the front outer globe face 110a, with at least FIG. 1 illustrating the cutout defined in the upper longitudinal surface of the body, by example. The cutout allows a user of the level to more easily view the front face of the globe when looking downwardly at the front face 40a of the level.

Although the figures illustrate a body 30 defining both lower and upper longitudinal surfaces, it is understood that other embodiments of the level 10 may utilize a body not having an upper surface and instead defining only the lower surface. It is further understood that the body may be non-elongated as well. For example, the at least one longitudinal surface 70 may have a length dimension. equal to or less than the height dimension defined by the opposing ends, with the body having a shape approximating a cube or other shape, for example. Regardless of the foregoing construction of the body, it is preferably comprised of lightweight, rigid and non-conductive materials, such as plastic, aluminum and/or fiber-reinforced polymer materials. The body may be made via molding, extrusion, machining or other manufacturing processes known in the art. However, any material enabling at least the rigid properties of the body may be utilized as well.

As illustrated in FIGS. 1-3, optionally located at the opposite ends 50 and 60 of the body 30 are end caps 230 and 240. The end caps protect the ends of the level's body from impact damage if the level is inadvertently dropped by the user. The end caps each preferably define an outer end surface 250, lower and upper longitudinal surfaces 260 and 270, and front and rear facial surfaces 280a and 280b. In one embodiment, the lower and upper longitudinal surfaces of each cap are co-planar with the lower and upper longitudinal surfaces 80 and 90 of the body while the front and rear facial surfaces of each cap are co-planar with at least the lower and upper outer portions 200a, 210a and 200b, 210b of the body's front and rear faces 40a and 40b. In another embodiment, the lower and upper longitudinal surfaces of each cap are recessed from the lower and upper longitudinal surfaces 80 and 90 of the body while the front and rear facial surfaces of each cap are recessed from at least the lower and upper outer portions 200a, 210a and 200b, 210b of the body's front and rear faces 40a and 40b such that the surfaces of each end cap are located inwardly of the respective surfaces of the body. Because the utilization of end caps on the level is optional, it is understood that other embodiments of the level do not have end caps located at the level's opposing ends.

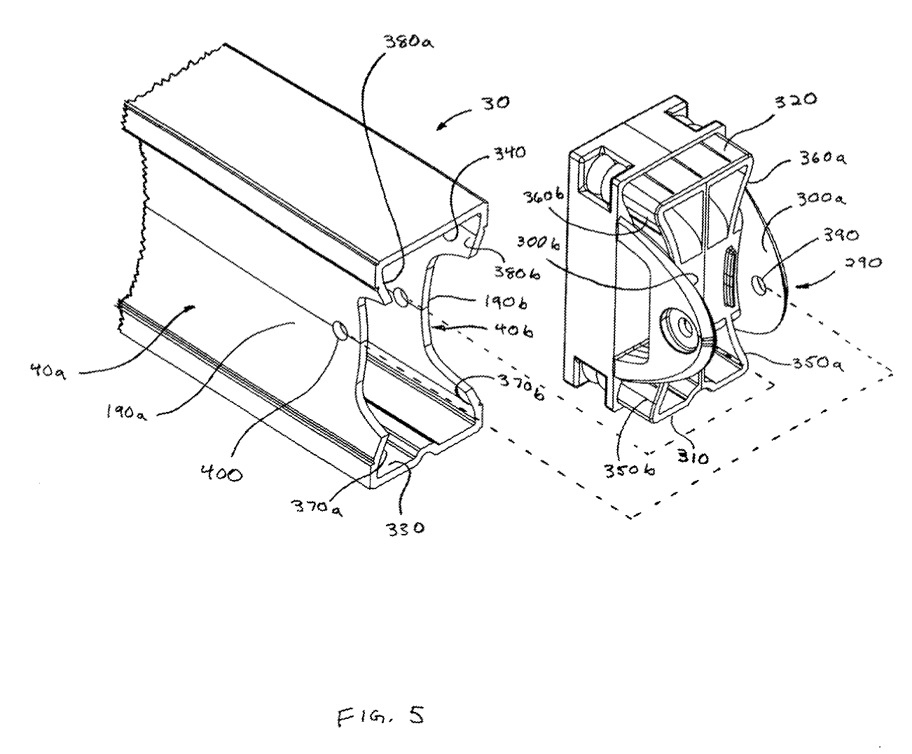

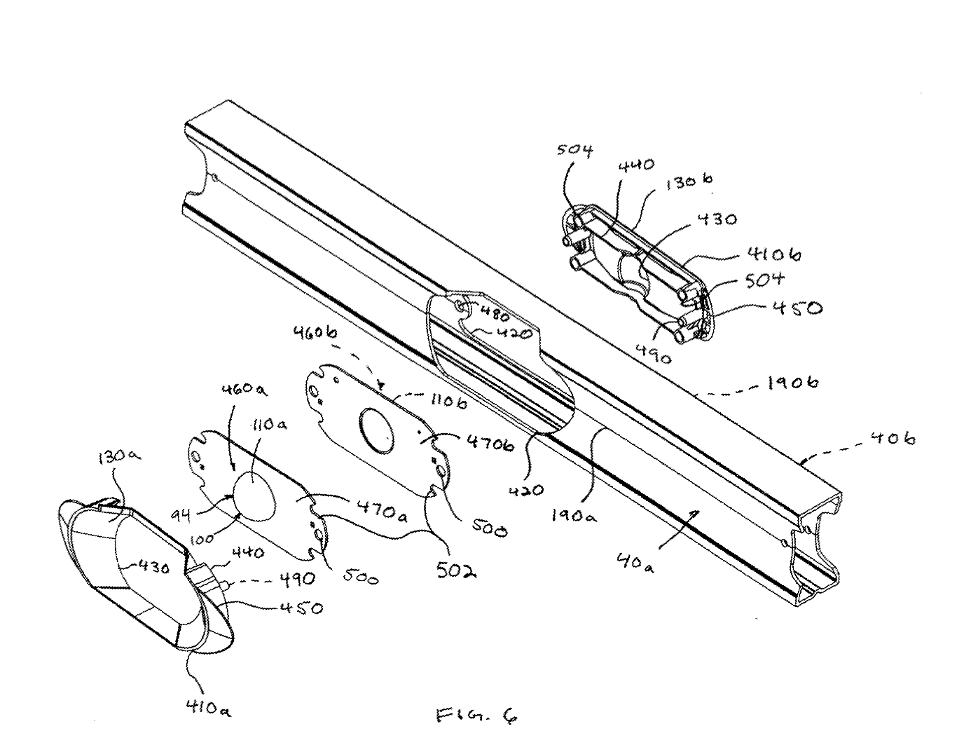

Referring to FIG. 5, each end cap preferably includes an inner end 290 defining offset, inwardly-directed surfaces 300a and 300b adapted for contact with the center portions 190a and 190b of the front and rear faces 40a and 40b of the body 30, respectively. Each end cap also defines offset lower and upper outwardly-directed longitudinal surfaces 310 and 320, for contact with inner lower and upper longitudinal surfaces 330 and 340 of the body, respectively, as well as outwardly-directed lower and upper facial surfaces, 350a, 360a and 350b, 360b, for respective contact with inner facial surfaces 370a, 380a and 370b, 380b of the body. Each end cap preferably includes a transverse bore 390 defined through the inner ends of the halves. A transverse bore 400 is also preferably defined proximal to each end of the body, through the center portions of the front and rear faces, such that, when the bore of a cap is coaxially aligned with the bore located proximal to the given end of the body, the end cap may be secured to the body via a bolt, screw, rivet or other fastener fastened there-through. However, it is understood that other constructions of the end caps are possible, and further that the end caps may be secured to the outer ends of the body via adhesive or any other means understood in the art. As further illustrated in FIGS. 1-3 and 6-7, the front and rear faces 40a and 40b of the body 30 optionally include the front and rear faces 130a and 130b of the bezel 120 for securing the outer vessel 94 (i.e., globe 100) at least partially between the front and rear faces of the body. Referring to FIG. 6, the front and rear faces of the bezel are thus preferably defined by respective front and rear bezel brackets 410a and 410b adapted for securement with the center portions 190a and 190b of the respective front and rear faces of the body. To facilitate the securement of the front and rear bezel brackets to the center portions of the front and rear faces of the body, at least one transverse opening 420 is defined through the center portions of the body's front and rear faces while each bracket further optionally defines a central, transverse void 430, an inwardly directed globe engagement surface 440 located about the void and an off-set, inwardly-directed body engagement surface 450.

The inwardly-directed globe engagement surfaces 440 of the front and rear bezel brackets 410a and 410b are adapted to extend into the at least one transverse opening 420 defined though the central portions 190a and 190b of the body's front and rear faces 40a and 40b and contact respective front and rear outer globe flanges, to be further discussed. The off-set, inwardly-directed body engagement surfaces 450 of the front and rear bezel brackets are adapted for contact with the center portions of the respective front and rear faces of the body 30 about the transverse opening defined through the central portion of the body's front and rear faces.

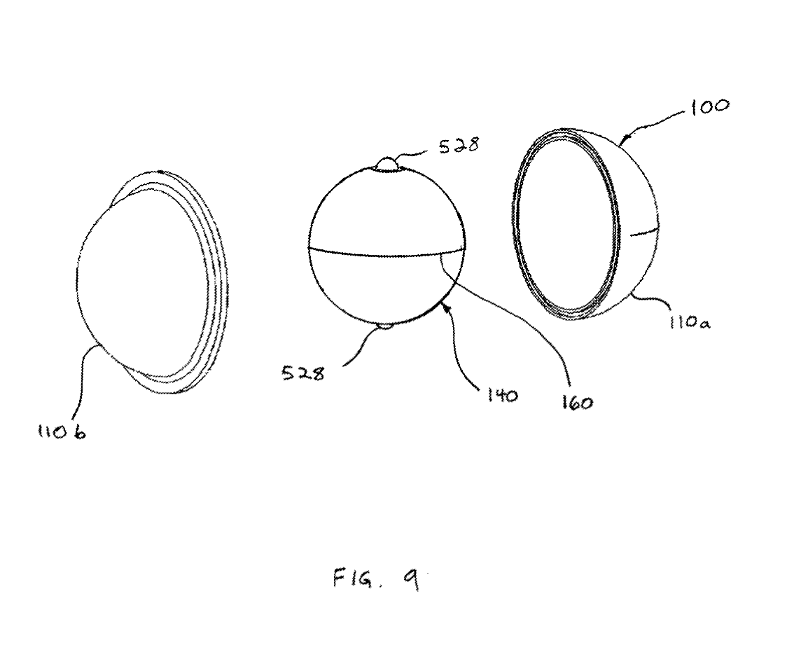

The optional central void 430 of each bezel bracket 410a and 410b, adapted for transverse, coaxial alignment with one another, defines an inner diameter that is greater than the outer diameter or a predetermined chord segment of the spherical outer globe 100. The spherical outer globe, comprising front and rear outer globe halves 460a and 460b respectively defining the globe's front and rear faces 110a and 110b, includes respective front and rear peripheral outer globe flanges 470a and 470b. In one embodiment, the front and rear peripheral flanges are unitary with the respective front and rear outer globe halves and are adapted to sealingly engage one another such that the liquid is maintained within the interior of the outer globe. In other embodiments, the front and rear outer globe halves 110a and 110b sealingly engage one another without peripheral flanges (FIG. 9) to define the outer globe 100, with the outer globe thereafter being affixed to the peripheral outer flanges.

Thus, in securing the outer globe 100 at least partially between the front and rear faces 40a and 40b of the body 30 in one embodiment of the invention, the front and rear bezel brackets 410a and 410b are located adjacent to the center portions 190a and 190b of the respective front and rear faces of the body such that the off-set, inwardly-directed body engagement surfaces 450 of the front and rear bezel brackets contact the center portions of the respective front and rear faces of the body about the at least one transverse opening 420 of the body. In this location, the inwardly-directed globe engagement surfaces 440 of the front and rear bezel bracket extend into the at least one transverse opening of the body for contact with at least the respective front and rear outer globe flanges 470a and 470b. For embodiments not utilizing globe flanges, the engagement surfaces of the bezel brackets engage the front and rear outer globe halves directly.

The front and rear globe halves 460a and 460b extend outwardly through the optional central voids 430 of the respective front and rear bezel brackets, while the front and rear globe flanges are “sandwiched” between the inwardly-directed globe engagement surfaces of the bezel brackets. At least the globe halves 460a and 460b are thus viewable through the optional central voids 430, with the globe flanges 470a and 470b thus optionally viewable through the central voids as well.

To maintain the front and rear bezel brackets 410a and 410b in the foregoing location, a pair of transverse bores 480 may be defined through the center portions 190a and 190b of the front and rear faces 40a and 40b of the body 30 such that the an opening of the at least one opening 420 of the body is located longitudinally between the bores. A pair of transverse bores 490 may thus be defined through the engagement surfaces 440 of the front and rear brackets 410a and 410b of the bezel 120 for respective coaxial alignment with the pair of bores of the body and a pair of bores 500 located in the peripheral flanges of the outer globe halves 460a and 460b, such that the bezel brackets may be secured to the body, with the flanges or globe halves secured there-between, via a pair of bolts screws, rivets or other fasteners fastened there-through.

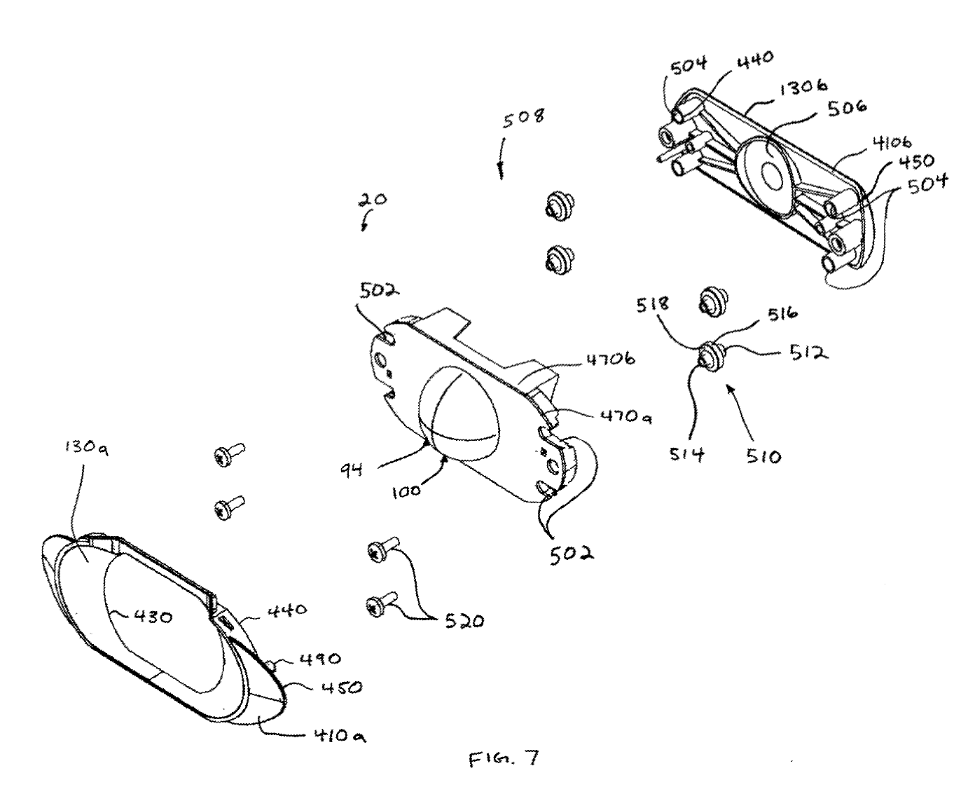

As further illustrated in FIGS. 6 and 7, inlets 502 are defined within the peripheral flanges 470a and 470b that are axially aligned with bores 504 defined within the engagement surfaces 440 of the rear bezel bracket 410b to facilitate a further securement of the components to one another via additional fasteners as understood in the art. The inlets 502 and bores 504 may optionally facilitate an adjustable connection between both flanges 470a and 470b and the rear bezel bracket 410b as well, to be further discussed.

It is understood, however, that other constructions of the bezel brackets are possible, and further that the bezel brackets may be secured to the body via adhesive or any other means understood in the art. For example, in other constructions of the bezel brackets 410a and 410b, either or both brackets may be constructed without the central void 430 such that either or both of the front and rear vessel halves 98a and 98b (i.e., globe halves 460a and 460b) do not extend outwardly therethrough. In such constructions, one or more of the bezel brackets may thus obscure the view of one of the globe halves and/or flanges 470a and 470b such that only one half and/or flange (i.e., only the front or rear half and/or flange) is visible, or either or both brackets omitting the void may be constructed entirely or partially of transparent or translucent material such that either or both globe halves and/or flanges are visible there-through. FIG. 7 thus illustrates an embodiment having the rear bezel bracket 410b constructed without the central void 430 such that the rear vessel half 98b (i.e., rear globe half 460b) does not extend outwardly there-through. In this embodiment, the rear bezel bracket has a panel 506 in place of the void 430 that obscures the view of the rear vessel half (i.e., rear globe half) and rear flanges 470b such that only the front half and flange is visible. Of course, the panel 506 may be constructed of transparent or translucent material to facilitate a view of the rear globe and flanges there-through as well.

FIG. 7 also illustrates an adjustment mechanism 508 for the at least one indicator 20. The adjustment mechanism allows a manufacturer to rotate the indicator about approximate horizontal and vertical axes, as defined by the level resting on its lower surface with a user viewing the level's front face, to adjust for manufacturing tolerances and ensure that the indicator is true in relation to the level's body 30. The adjustment mechanism is preferably comprised of a plurality of adjustable fittings 510 located about the outer globe and adjustably connecting the front and rear flanges 470a and 470b together to the rear bezel 410b. The fittings are preferably symmetrically located about the top right, bottom right, top left and bottom left of the outer globe 100. Each fitting, facilitating a depth adjustment of the flanges in relation to the rear bezel, is comprised of a post 512 defining a threaded socket 514 within an outer end thereof and a nut 516 threadedly engaged about the outer end of the post, with the nut defining an outer face 518. The post of each fitting is affixed within the socket 504 of the rear bezel 410b, the front face of each nut abuts the rear flange 470b of the flanges, and the threaded socket of the post is in axial alignment with each inlet 502 defined through the flanges. Screws 520, respectively driven through each inlet of the flanges and into the threaded socket of each post, adjustably secure the flanges to the fittings and thus the rear bezel.

A depth adjustment of each fitting is thus accomplished via a rotation of each nut (i.e., of the four nuts abutting the rear flange of the flanges of the indicator) inwardly or outwardly. The inwardly or outwardly rotation of the respective nuts thus results in an inwardly or outwardly movement of the flanges of the indicator. For example, if the top two nuts are rotated outwardly and the bottom two nuts are rotated inwardly, the indicator, via the flange abutting the nuts, is adjusted such that it rotates about a horizontal axis. If the top and bottom right-side nuts are rotated outwardly and the top and bottom left-side nuts are rotated inwardly, the indicator, via the flange abutting the nuts, is adjusted such that it rotates about a vertical axis. Of course, the nuts may be rotated inwardly or outwardly in various combinations to facilitate an adjustment of the indicator in various directions.

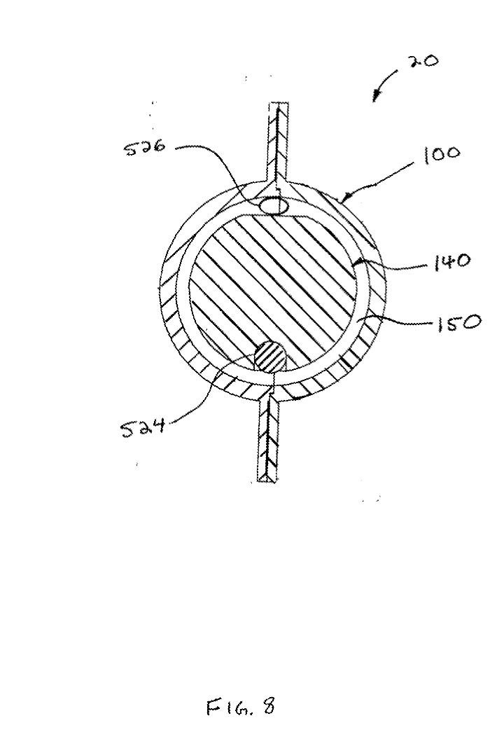

To allow the inner vessel 134 (i.e., globe 140) to be viewable through the outer vessel 94 (i.e., globe 100), the front and rear halves 98a and 98b of the outer vessel (i.e. front and rear halves 460a and 460b of the outer globe) are comprised of transparent or translucent plastic or glass. The liquid 150, optionally located within the outer globe and substantially surrounding the inner globe, is also transparent or translucent to allow the inner globe to be viewable therethrough. The liquid is preferably comprised of alcohol, mineral oil or other oils, or any other temperature-stable substance that facilitates the buoyant properties of the inner globe. As illustrated in FIG. 8, which shows a cross-section of the inner and outer globes 100 and 140 of the indicator 20 of FIG. 1, the inner globe may thus be hollow and filled with a gas, and/or partially solid or solid and comprised of a material (i.e., plastic, cork, wood, etc.) tending to float within the liquid 150. To enable its buoyant properties, the inner globe includes a weight 524, located proximal to an outer periphery thereof, to both define a bottom of the globe and maintain the globe in an “upright” position within the liquid of the outer globe. A bearing 526, such as a gas bubble, may be located between the inner and outer globes, proximal to a top of the inner globe, to minimize frictional contact between the two. The outer globe 100 has a diameter of at least about 10 millimeters (mm), preferably from about 12.5 millimeters (mm) to about 89 millimeters (mm), and more preferably about 48 millimeters (mm). The inner globe 140 has a diameter of at least about 6 millimeters (mm), preferably from about 8.5 millimeters (mm) to about 81 millimeters (mm), and more preferably about 40 millimeters (mm). It is understood, however, that inner and outer globe diameters of any dimension may be utilized.

Referring to FIG. 9, in yet a further embodiment, the substantially spherical inner globe 140 is located within the outer globe 100 and is supported by a mechanical means located there-between, with the inner globe again viewable through the outer globe, defining an equator 160 around its outer periphery, and buoyantly biased within to maintain the equator in a substantially horizontal position. For example, the mechanical means may comprise one or more ball bearings 528 located between the inner and outer globes to buoyantly support the inner globe therein. In the embodiment illustrated in FIG. 9, the one or more ball bearings 528 are located at the top and bottom of the inner globe 140 to buoyantly support it within the outer globe 100. It is understood, however, that additional ball bearing may be located at other areas of the inner globe, such as about the equator, to further support the inner globe within the outer globe.

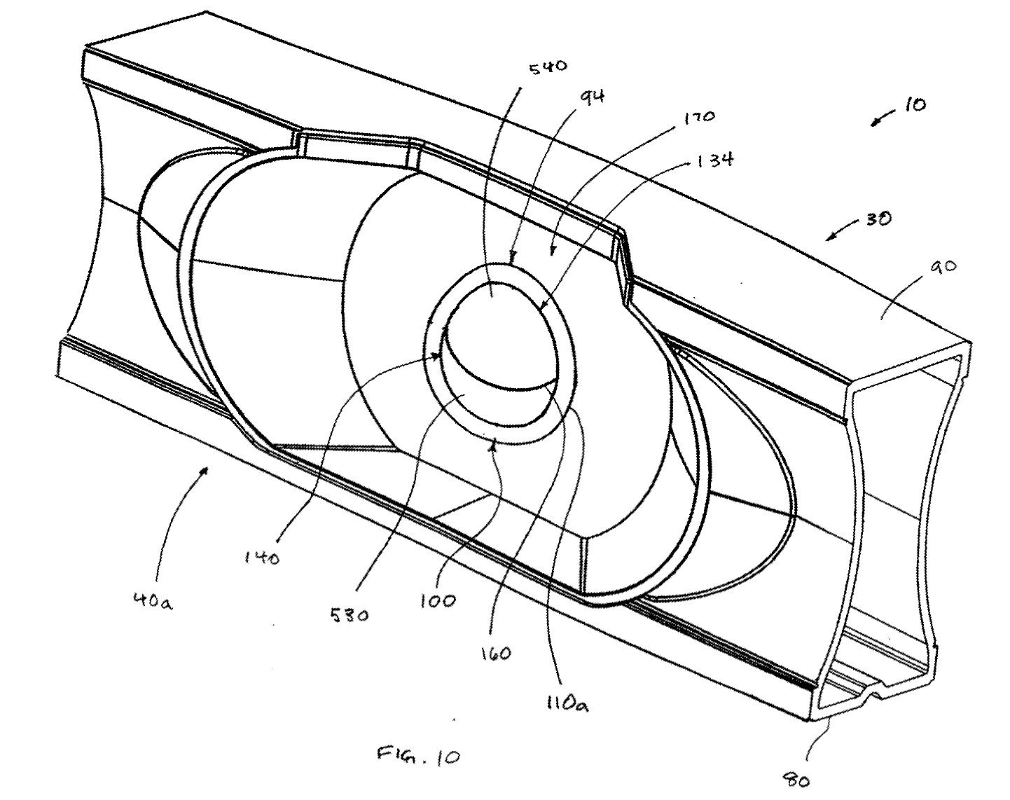

FIGS. 10-13 illustrate close-up elevation views of the front face 40a of the level 10 resting on its lower longitudinal surface 80. Referring initially to FIG. 10, the inner globe 140 includes the equator 160 defined around its outer periphery that divides the inner globe into equal and symmetrical lower and upper hemispheres 530 and 540. In the illustrated embodiment, the equator is defined by a line drawn around the globe's outer periphery, with the lower and upper hemisphere having a common color. However, in other embodiments not illustrated herein, the equator of the inner globe is defined by respective contrasting colors (i.e., black and white) of the globe's lower and upper hemispheres. Regardless of how the equator is defined on the inner globe, it is in operable registry relation with the first indicia 170 to indicate a position of the at least one longitudinal surface of the body in relation to the adjacent surface or line in question.

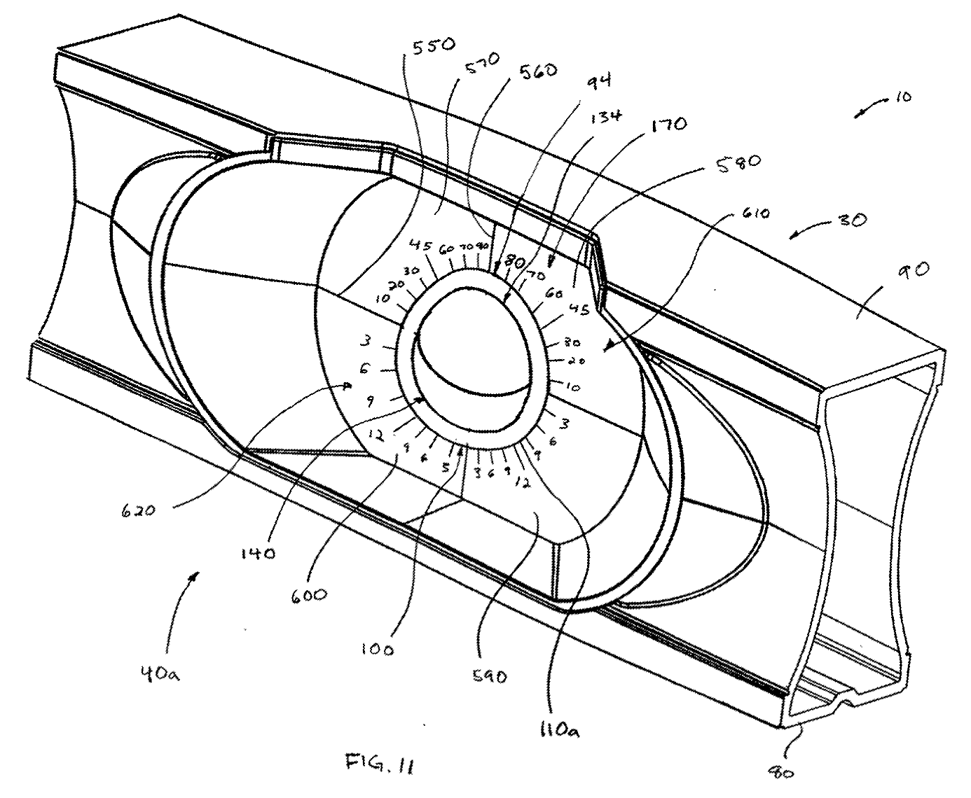

As best illustrated in the embodiment of FIG. 11, the first indicia 170 comprises X and Y axes intersecting one another at 90 degrees, with the outer ends 550 and 560 of the axes located on the front face 40a of the level about the outer vessel 94 (i.e., globe 100) of the indicator to define four quadrants 570, 580, 590 and 600. The X and Y axes and quadrants of the first indicia located about the outer globe may thus be located on the body 30 of the level, on one or more of the level's bezels 130a and 130b, on one or more of the outer globe's flanges 470a and 470b, or between the outer globe's flanges. For example, where the X and Y axes and quadrants of the first indicia are located between the front and rear flanges, the flanges are transparent or translucent and have an illustration of the axes and quadrants thereon sandwiched there-between such that the illustration is viewable through at least one of the flanges (i.e., through the front flange). Assuming a horizontal orientation of the longitudinal, elongated body 30, the lines of the X and Y axes define horizontal and vertical reference lines, with the horizontal X axis lying parallel to the lower and upper longitudinal surfaces 80 and 90 of body and the vertical Y axis lying perpendicular to the X axis and the body's lower and upper longitudinal surfaces. Where the X and Y axes and quadrants of the first indicia are located on or between the globe's flanges, an adjustment of the optional adjustment mechanism 508, as previously discussed herein in relation to FIG.7, ensures that the quadrant and axes are also true in relation to the level's body.

The quadrants of the first indicia discussed above may optionally include markings 610 and 620 indicating indexed angle and/or pitch values, respectively. The angle values preferably define a range of from about 0 to about 90 degrees of inclination or declination, per quadrant, with about 45 degrees defining the quadrant's mid-point. The pitch values preferably define a range of from about 0 inches of rise per 12 inch run to about 12 inches of rise per 12 inch run, and back to about 0 inches of rise per 12 inch run, per quadrant, with about 12 inches of rise per 12 inch run comprising the quadrant's mid-point. In other embodiments, the pitch values define a range of from about 0 inches of rise per 12 inch run to about 40 inches of rise per 12 inch run, with about 12 inches of rise per 12 inch run again defining the mid-point. It is understood, however, that other combinations of angle and/or pitch markings may be utilized in other configurations as well. For example, the pitch marking may indicate 0, ⅛, ¼, ⅜ and ½ inch per foot measurements, common to plumbers, or other common measurements as well. It is also understood that the pitch values can read in metric denominations as well.

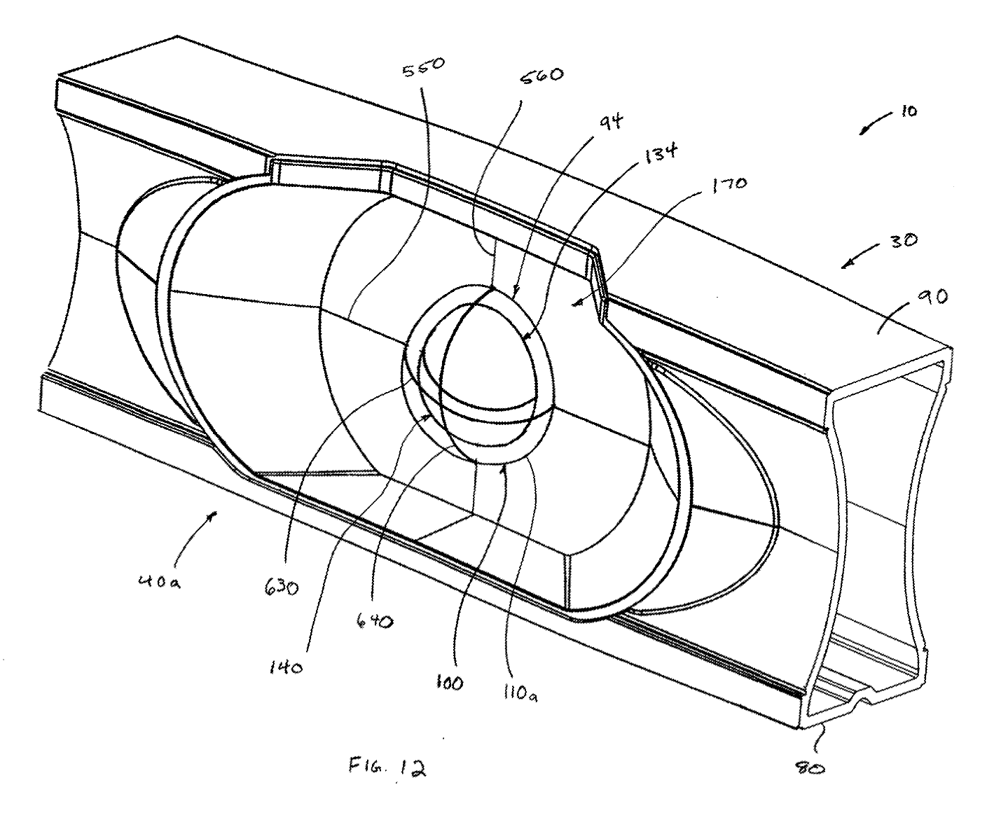

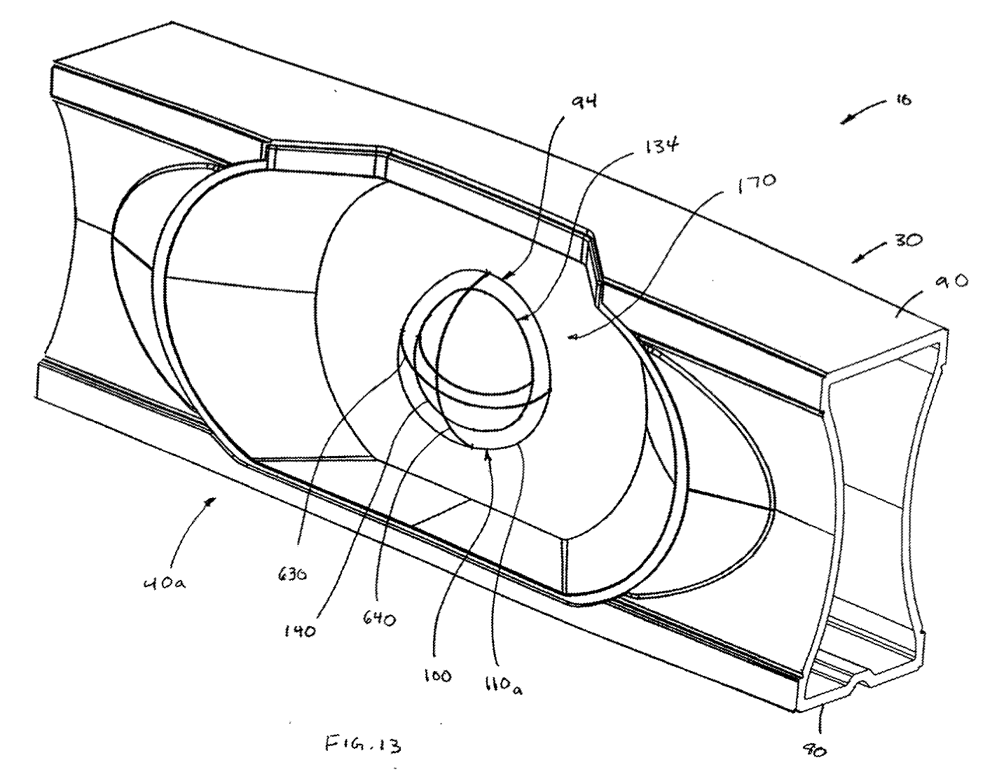

The four quadrants 570, 580, 590 and 600 of the first indicia 170 may optionally define two pairs of quadrants of contrasting color, with each quadrant of a common-color pair located diametrically opposite of one another. The quadrants of a one color may be utilized when determining the degrees of inclination and/or pitch of a given line or surface from the horizontal while quadrants of the contrasting color may be utilized in determining the degrees of inclination and/or pitch of a given line or surface from the vertical. The first indicia 170, may additionally (FIG. 12) or alternatively (FIG. 13) include a horizontal circumferal equator 630 and a vertical circumferal line 640, preferably located on the front face 110a of the outer globe 100, that intersect one another at 90 degrees. The circumferal equator and vertical circumferal lines define X and Y axes on the front face of the outer globe that, in turn, define horizontal and vertical reference lines. In defining horizontal and vertical reference lines, the outer globe's horizontal X axis again lies parallel to the lower and upper longitudinal surfaces 80 and 90 of the body 30 while its vertical Y axis again lies perpendicular to the X axis and the body's lower and upper longitudinal surfaces. If used in addition to the X and Y axes located on the front face of the body (FIG. 12), the X and Y axes of the outer globe are respectively aligned with the outer ends 550 and 560 of the X and Y located about the globe. With regard to the operable registry relation of the inner globe's equator 160 with the first indicia l 70, the equator, buoyantly biased in the horizontal position, will lie in registry with the outer ends 550 of the X axis located on the front face 40a of the body about the outer globe and/or the X axis 630 located on the front face 110a of the outer globe 100 when the at least one longitudinal surface 70 (i.e., a lower, or optionally upper, longitudinal surface 80 or 90) of the level is positioned adjacent to the horizontal surface or line in question 180. The equator, again. buoyantly biased in the horizontal position, will similarly lie in registry with the outer ends 560 of the Y axis located on the front face of the body about the outer globe and/or the Y axis 640 located on the front face of the outer globe when the at least one longitudinal surface is positioned along a vertical surface or line in question. Of course, if a given line or surface in question deviates from the horizontal or vertical, the equator will lie in registry with the optional indexed angle and/or pitch values 610 and/or 620 of the quadrants to indicate the degree and/or pitch of the deviation.

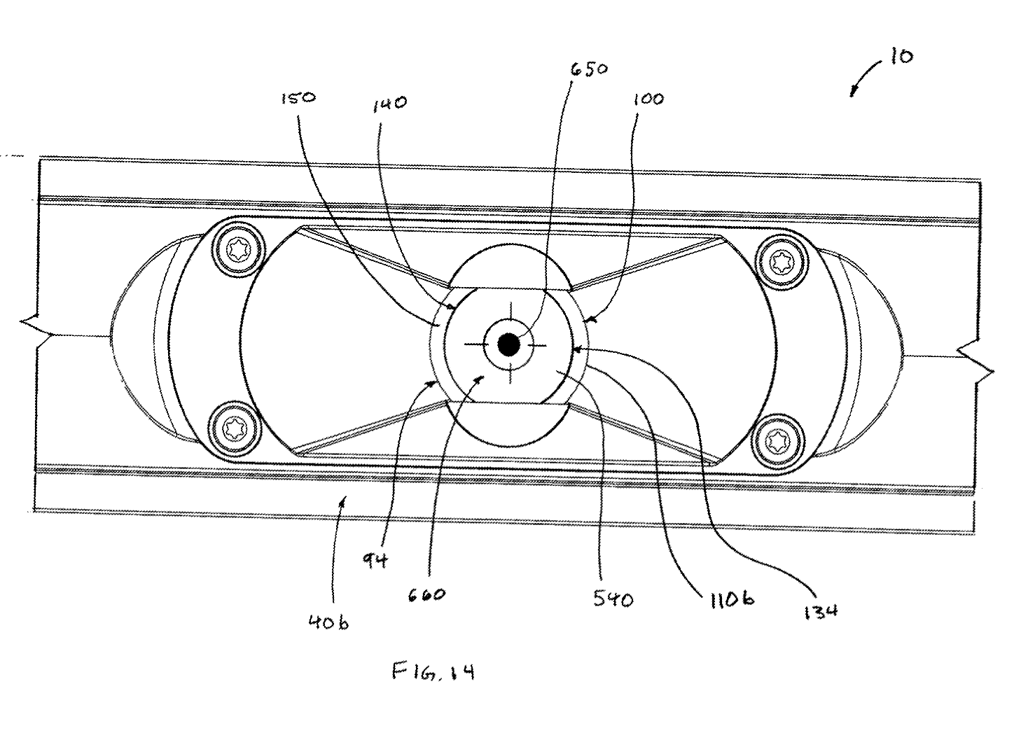

FIG. 14 is a close-up plan view of the rear face 40b of the level 10 illustrating the level resting on its front face.40a such that the front face of the level is lying horizontally and facing downwardly (i.e., in a “face down” position) and the rear face of the level is lying horizontally and facing upwardly (i.e., in a “face up” position). For the sake better illustrating the inner globe, bearing 526 has been omitted for clarity. The inner globe 140 is suspended in the upright position within the liquid 150 of the outer globe 100 such that the inner globe's upper hemisphere 540 is facing upwardly and its lower hemisphere 530 is not visible because it is facing downwardly. The inner globe includes a polar marking 650 concentrically centered within the outer periphery of the upper hemisphere defined by the equator, with the marking in operable registry relation with a second indicia 660 to indicate a position of the front face of the body in relation to a surface in question 180 located adjacent to the front face. Although the polar marking comprises a solid circle within FIG. 14, the polar marking may comprise a cross-hair or other marking as well.

The second indicia 660 preferably comprises a circle and/or cross-hair concentrically located on the rear face 110b of the outer globe 100, as viewed from the rear face 40b of the body. The cross-hair may optionally include index lines or gradations to allow a user to determine a percent of grade or elevation. Such index lines or gradations along one or both axes of the crosshair may indicate 0, ⅛, ¼, ⅜ and ½ inch per foot measurements, common to plumbers, or other common measurements as well. The second indicia of the outer globe, when used in operable registry relation with the polar marking 650 of the inner globe 140, allows for an indication and/or measurement of an angle of deviation of a surface in question from a horizontal plane in at least two directions. Thus, with regard to the operable registry relation of the inner globe's polar marking with the second indicia, the polar marking will lie in registry with the circle and/or cross-hair located on the rear face of the outer globe when the front face of the level is positioned along a horizontal surface in question.

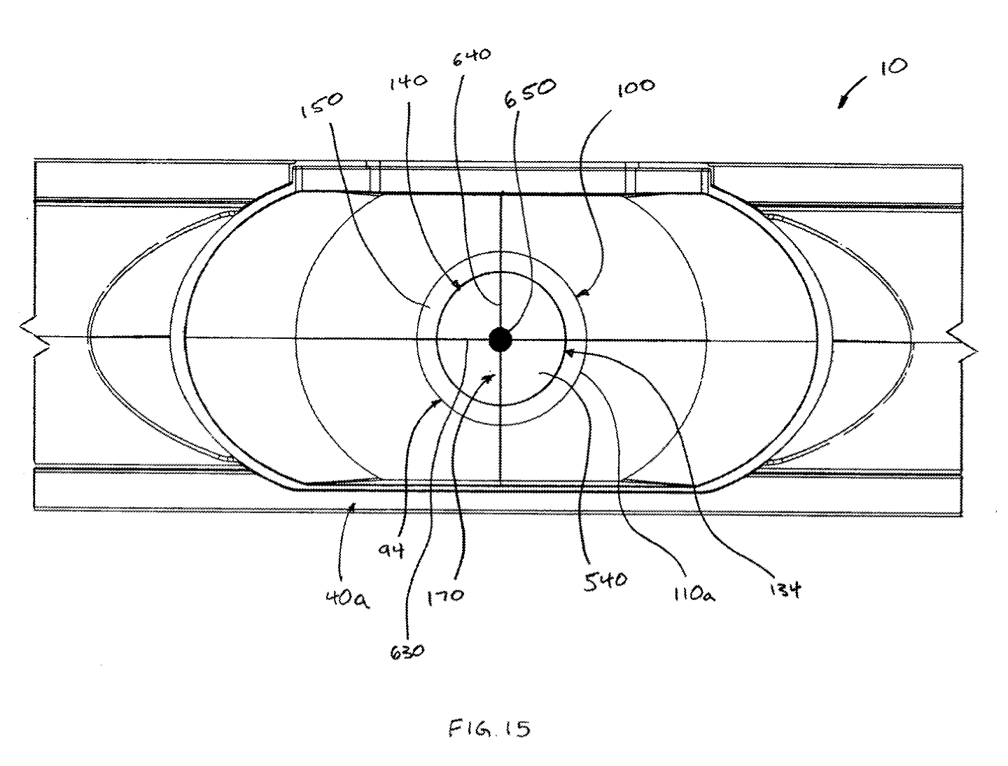

In other embodiments of the invention, the polar marking of the inner globe is in operable registry relation with the first indicia 170 (i.e., the X and Y axes located on the front face 110a of the outer globe) to indicate a position of the rear face of the body in relation to a surface in question 180 located adjacent to the rear face. FIG. 15 thus illustrates a close-up plan view of the front face 40a of the level 10 illustrating the level resting on its rear face 40b such that the rear face of the level is lying horizontally and facing downwardly (i.e., in a “face down” position) and the front face of the level is lying horizontally and facing upwardly (i.e., in a “face up” position). The inner globe 140 is again suspended in the upright position within the liquid 150 of the outer globe 100 such that the inner globe's upper hemisphere 540 is facing upwardly and its lower hemisphere 530 is not visible because it is facing downwardly. The polar marking 650 of the inner globe is in operable registry relation with the first indicia embodiment 170 of FIG. 12 to indicate a position of the rear face of the body in relation to a surface in question 180 located adjacent to the rear face. Thus, with regard to the operable registry relation of the inner globe's polar marking with the first indicia, the polar marking will lie in registry with the intersection of the X and Y axes 630 and 640 located on the front face of the outer globe when the rear face of the level is positioned along a surface in question. The cross.-hair defined by the X and Y axes may again optionally include index lines or gradations to allow a user to determine a percent of grade or elevation. Such index lines or gradations along one or both axes of the crosshair may indicate 0, ⅛, ¼, ⅜ and ½ inch per foot measurements, common to plumbers, or other common measurements as well.

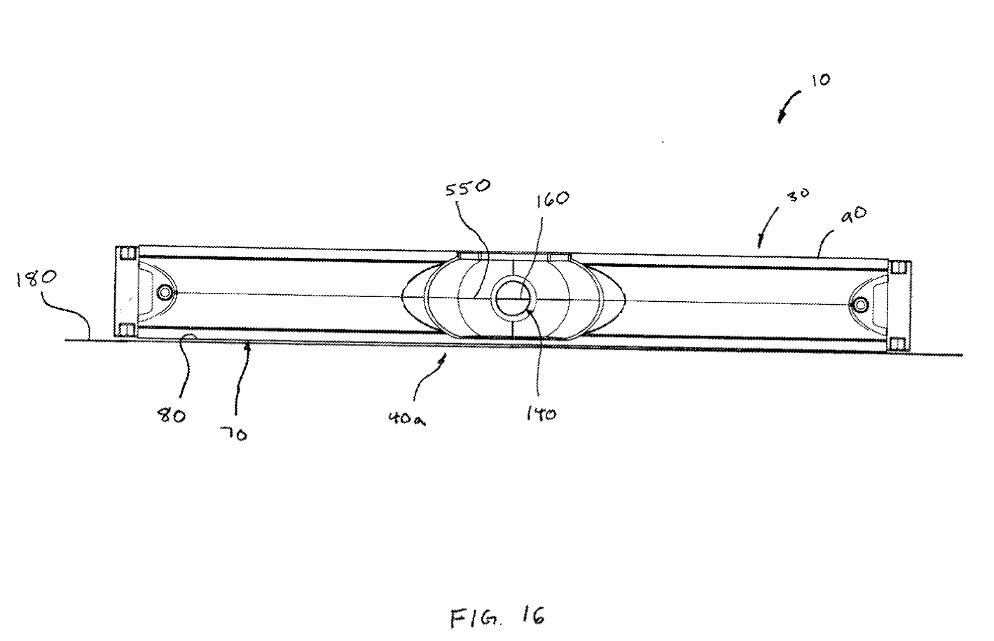

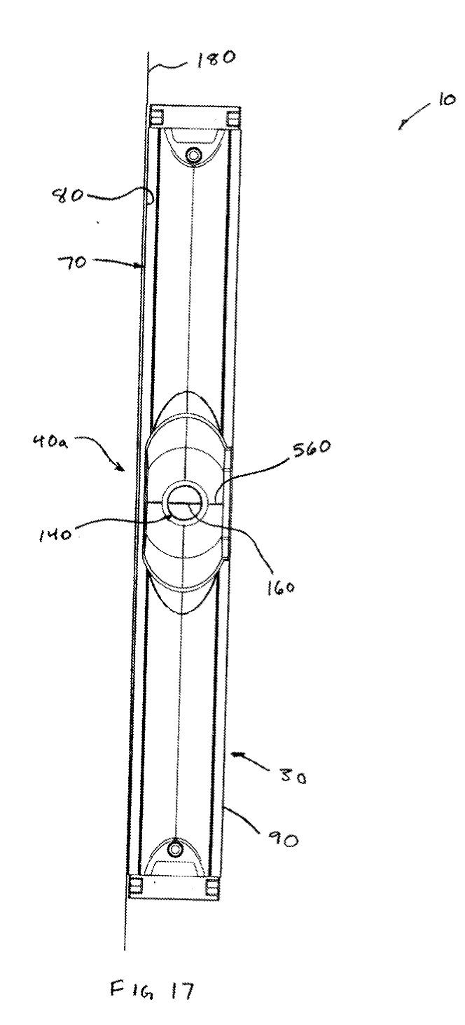

FIGS. 16-19 and 21, for the sake of clarity in illustrating the equator of the inner globe of the indicator, show the first indicia of the level including only the outer ends 550 and 560 of the X and Y axes on the body's front face. However, it is understood that the X and Y axes of the outer globe's front face may be additionally or alternatively included as well. Referring to FIG. 16, in a use of the level in determining whether a given line or surface in question 180 is approximately horizontal (i.e., level), the at least one longitudinal surface 70 of the body 30 (i.e., the lower longitudinal surface 80 of the body, or the upper longitudinal surface 90, if present) of the level 10 is positioned adjacent to the given line or surface in question. The equator 160 of the inner globe 140 is generally horizontal and aligned in registry with the outer ends 550 of the X axis of the body's front face 40a when the given line or surface in question is horizontal. Referring to FIG. 17, in determining whether a given line or surface is question 180 is approximately vertical (i.e., plumb), the at least one longitudinal surface 70 of the body 30 (i.e., the lower longitudinal 80 of the body, or the upper longitudinal surface 90, if present) of the level 10 is positioned adjacent to the given line or surface in question. The equator 160 of the inner globe 140 is again generally horizontal, but aligned in registry with outer ends 560 of the vertical Y axis of the body's front face 40a when the given line or surface in question is vertical. Thus, in both of the foregoing horizontal and vertical determinations, the operable registry relation between the equator of the inner globe and the first indicia is in relation to a positioning of the at least one longitudinal surface of the level's body.

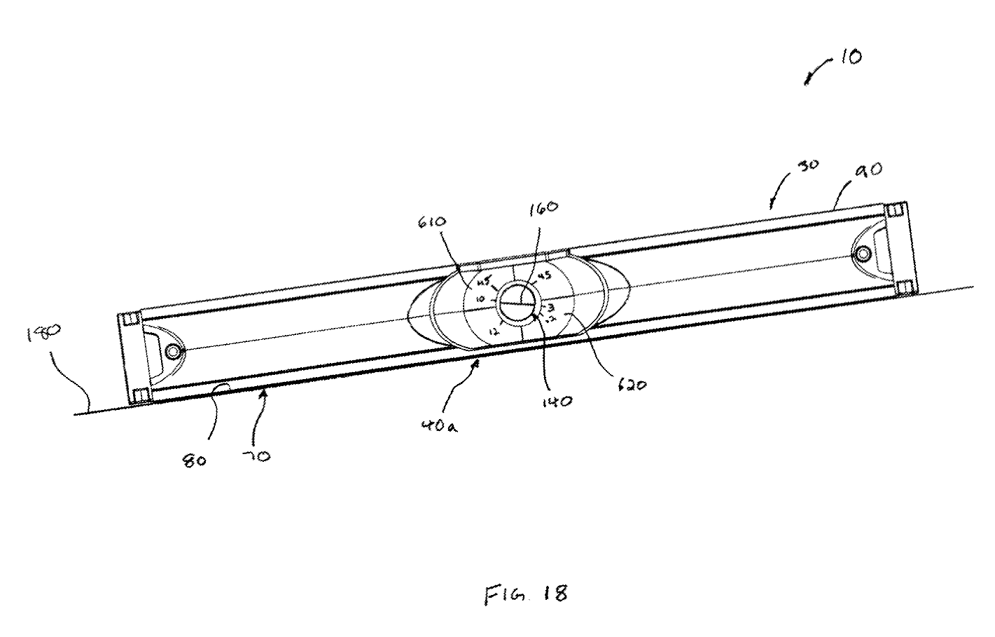

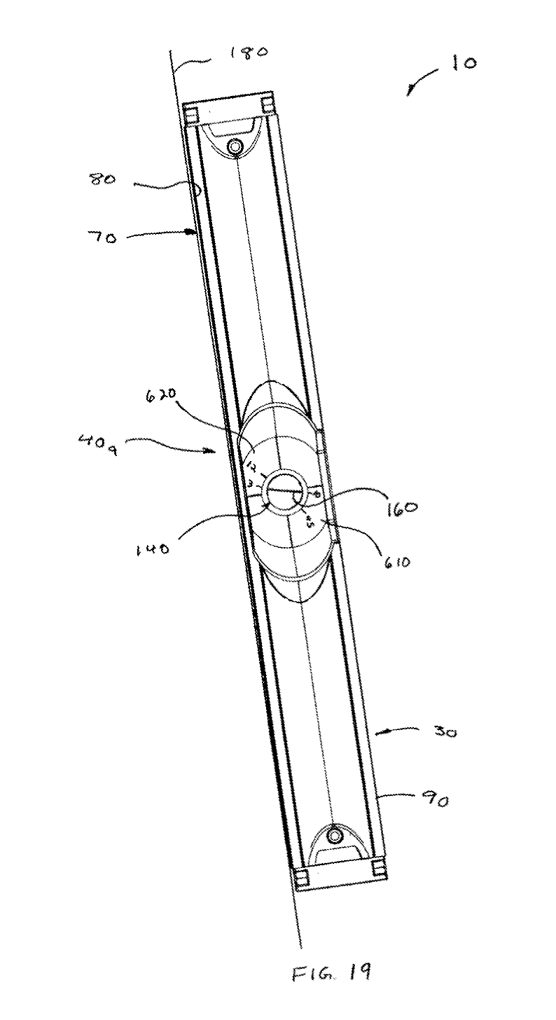

As illustrated in FIG. 18, in use in determining the angle of inclination or pitch of a given line or surface in question 180 from the horizontal, the at least one longitudinal surface 70 of the body 30 (i.e., the lower longitudinal surface 80 of the body, or the upper longitudinal surface 90, if present) of the level 10 is positioned adjacent to the given line or surface in question. The equator 160 of the inner globe 140 is generally horizontal and aligned in registry with the first indicia reciting angle degrees of inclination 610 and/or pitch 620, respectively, to indicate the respective angle and/or pitch values of the given line or surface in question. As illustrated in FIG. 19, in determining the angle of inclination or pitch of a given line or surface in question 180 from the vertical, the at least one longitudinal surface 70 of the body 30 (i.e., the lower longitudinal surface 80 of the body, or the upper longitudinal surface 90, if present) of the level 10 is positioned adjacent to the given line or surface in question. The equator 160 of the inner globe 140 is again generally horizontal, but aligned in registry with the first indicia reciting angle degrees of inclination 610 and/or pitch 620, respectively, to indicate the respective angle and/or pitch values of the given line or surface in question.

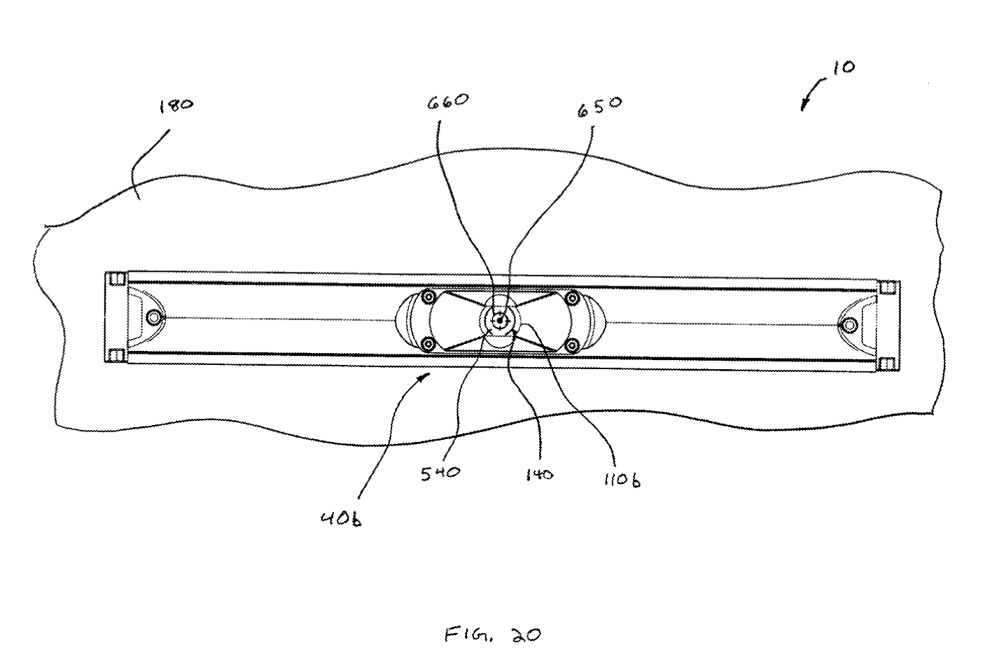

Referring to FIG. 20, in determining whether a given surface 180 is approximately horizontal (i.e. level) in at least two directions along a plane, the front face 40a of the body 30 of the level 10 is positioned adjacent to and “face down” in relation to the given surface in question, with the rear face 40b of the body of the level thus oriented in a “face up” position. The polar marking 650 of the upper hemisphere 540 of the inner globe 140 is generally concentrically aligned with the center of second indicia 660 (i.e., the cross-hairs and/or plurality of concentric rings) of the outer globe's rear face 110b when the given surface in question is indeed horizontal along the at least two directions. For determining whether a given structure (i.e., a post or column) is approximately vertical (i.e. plumb) along at least two directions, not illustrated herein, it is assumed that an end surface of the post or column is perpendicular to its approximately vertical sides. The front face 40a of the body 30 of the level is positioned adjacent to and “face down” in relation to the end surface of the post or column. The rear face 40b of the body of the level thus faces upwardly. The polar marking 650 of the upper hemisphere 540 of the inner globe 140 is again concentrically aligned with the second indicia 660 (i.e., center of the cross-hairs and/or plurality of concentric rings) of the outer globe's rear face 110b when the sides of the post or column are indeed vertical along the at least two directions. Thus, in both the foregoing horizontal and vertical determinations, the operable registry relation between the marking of the inner globe and the second indicia of the rear face of the outer globe is in relation to a positioning of the front face of the level's body. If the second indicia includes index lines or gradations, a deviation a deviation of a surface in question from the horizontal or vertical along at least two directions may be determined as well via an alignment or registry relation of the polar marking with such index lines or gradations.

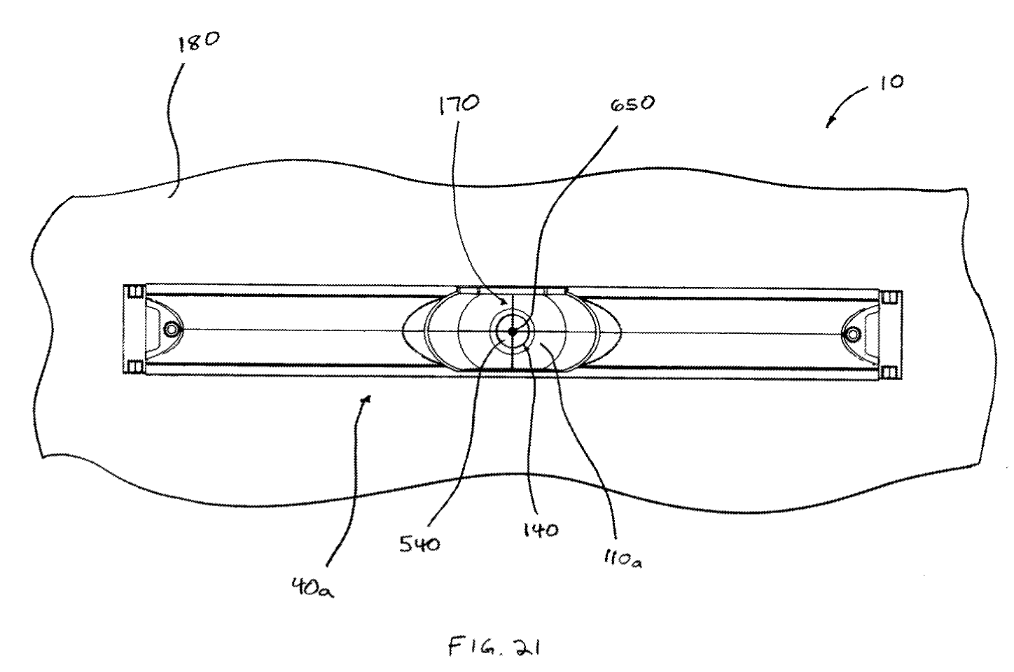

In use in the embodiment illustrated in FIG. 21, in determining whether a given surface 180 is approximately horizontal (i.e. level) in at least two directions along a plane, the rear face 40b of the body 30 of the level 10 is positioned adjacent to and “face down” in relation to the given surface in question, with the front face 40a of the body of the level thus oriented in a “face up” position. The polar marking 650 ofthe upper hemisphere 540 of the inner globe 140 is generally concentrically aligned with the first indicia 170 (i.e., X and Y axes 630 and 640) of the outer globe's front face 110a when the given surface in question is indeed horizontal along the at least two directions. For determining whether a given structure (i.e., a post or column) is approximately vertical (i.e. plumb) along at least two directions, again not illustrated herein, it is again assumed that an end surface of the post or column is perpendicular to its approximately vertical sides. The rear face 40b of the body 30 of the level is positioned adjacent to and “face down” in relation to the end surface of the post or column. The front face 40a of the body of the level thus faces upwardly. The polar marking 650 of the upper hemisphere 540 of the inner globe 140 is again concentrically aligned with the first indicia 170 (i.e., X and Y axes) of the outer globe's front face 110a when the sides of the post or column are indeed vertical along the at least two directions. Thus, in both the foregoing horizontal and vertical determinations, the operable registry relation between the marking of the inner globe and the first indicia of the front face of the outer globe is in relation to a positioning of the rear face of the level's body. If the first indicia includes index lines or gradations, a deviation of a surface in question from the horizontal or vertical along at least two directions may be determined as well via an alignment or registry relation of the polar marking with such index lines or gradations.

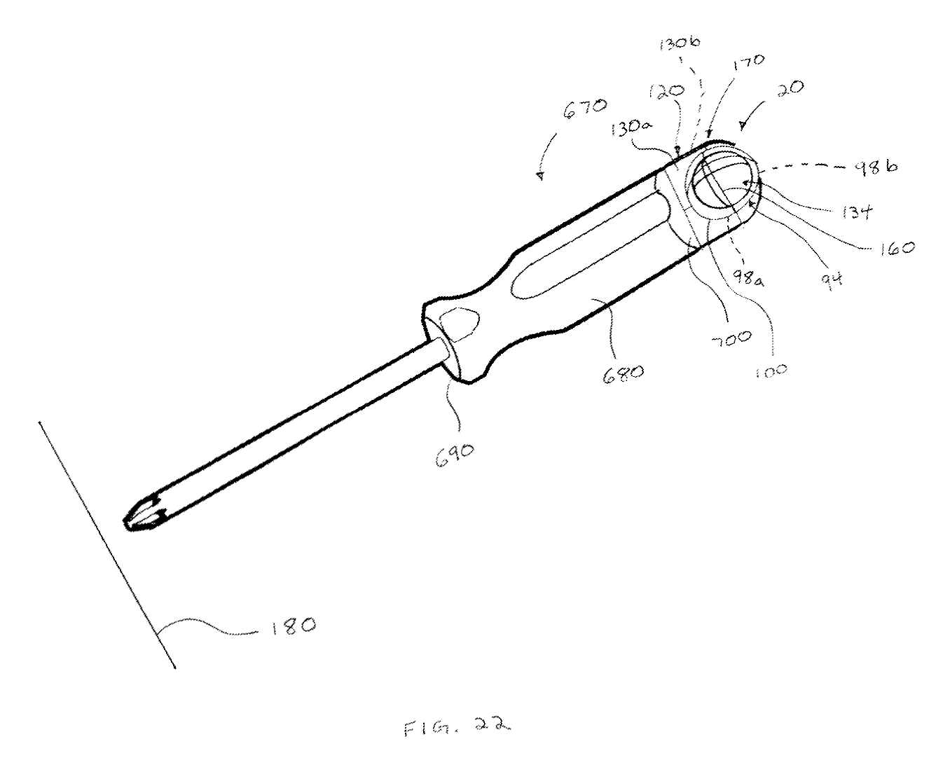

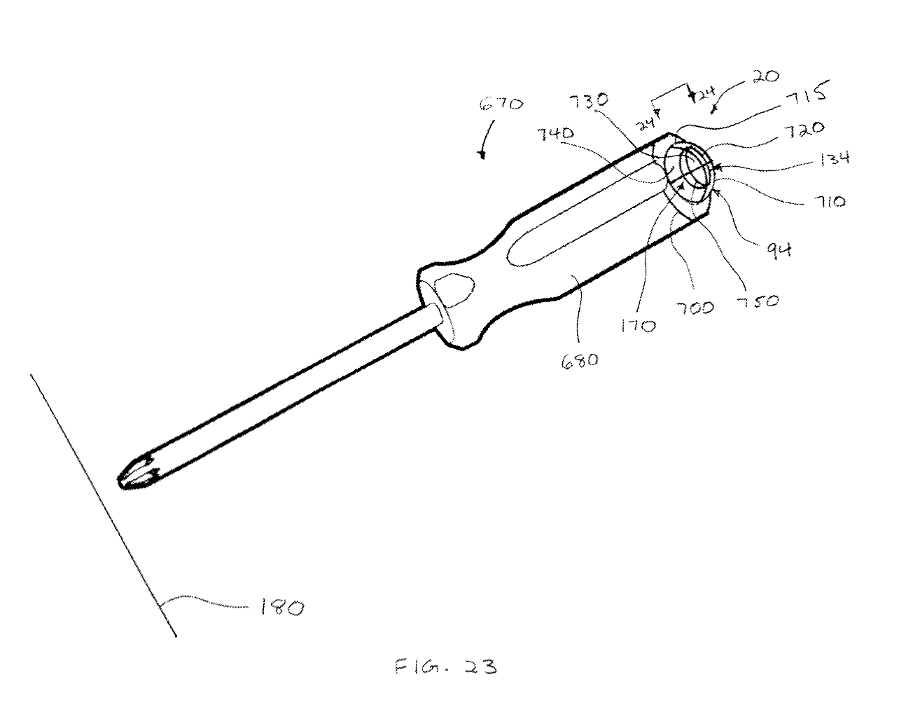

FIGS. 22 and 23 illustrate various embodiments of the at least one indicator 20 located on a tool 670. While a screwdriver is indicated as the tool 670 of FIG. 22 for the sake of example, it is understood that numerous other tools having the at least one indicator 20 may be illustrated as well. For example, such tools may include a chisel, jig saw, circular saw, miter saw, wrench, drill, shovel, knife, marking tool, machine tool or any other tool that would benefit from having the at least one indicator 20 operably associated therewith.

Referring to initially to FIG. 22, the tool 670 comprises at least one indicator 20 located on a body 680 of the tool. The body of the tool defines a pair of opposing ends 690 and 700, with an outer vessel 94 of the at least one indicator 20 located at one end of the body. In the embodiment illustrated in FIG. 22, the outer vessel of the indicator defines a spherical outer globe 100. In other embodiments, the outer vessel may define a cube, truncated cube or rhombicuboctahedron defining front and rear cube faces, a spherical or arcuate segment, or other geometric shapes understood in the art. Any of the foregoing geometric shapes may optionally have outwardly-acuate sides or faces as well.

The body 680 of the tool optionally includes a bezel 120 having front and rear faces 130a and 130b. In the embodiment of the tool 670 illustrated in FIG. 22, the bezel's 120 front and rear faces 130a and 130b are molded into and unitary with the tool's body 680. It is understood, however, that other constructions of the bezel are possible, and further that the bezel may be secured to the body via adhesive or any other means understood in the art. Furthermore, while the bezel 120 divides the outer vessel into front and rear faces 98a and 98b, one or more additional bezels, or no bezel, may be utilized as well. For example, a second bezel, oriented at an angle of 90 degrees to bezel 120, may be utilized to divide the outer vessel into four separate faces or quadrants. Also, unless otherwise recited herein with different reference numbers, the embodiments of the at least one indicator 20 and bezel 120 of the tool 670 are comprised of the same components of the at least one indicator 20 of the level.

An inner vessel 134 of the at least one indicator is located within the outer vessel 94. The inner vessel, viewable through the outer vessel and preferably defining an equator 160 around its outer periphery, is buoyantly biased to maintain the equator in a substantially horizontal position. The inner vessel may be buoyantly supported within the outer vessel via a liquid or via a mechanical means, to be further discussed. The equator is in operable registry relation with a first indicia 170, located on the outer vessel 94 and/or bezel 170, to indicate a position of the tool in relation to a surface or line in question 180.

Embodiments of the inner vessel 134 may define an ovular sphere, spherical cone, any variation of dipyramid, bipyramid or deltahedron, a spherical or arcuate segment, or any other geometric form understood in the art capable of maintaining a buoyant position. However, in the embodiment of FIG. 22, the inner vessel 134 of the at least one indicator comprises a substantially spherical inner globe 140, with the inner globe located within the outer globe 140 and supported by liquid 150 located within the outer globe. While FIG. 22 illustrates the inner and outer vessels 134 and 94 as being entirely visible, it is understood that the inner and/or outer vessels may be only partially visible as well. For example, the outer vessel 94 may be embedded into the body of the tool such that only a portion (i.e., half, or some other portion) of the inner and outer vessels are visible to the eye. The inner globe, viewable through both the liquid and the outer globe and again defining an equator 160 around its outer periphery, is buoyantly biased within the liquid to maintain the equator in a substantially horizontal position. See FIG. 8 and the accompanying relevant text set forth in previous sections of this written description.

In other embodiments, the substantially spherical inner globe 140 is located within the outer globe and is supported by mechanical means located there-between, with the inner globe again viewable through the outer globe, defining an equator 160 around its outer periphery, and buoyantly biased to maintain the equator in a substantially horizontal position. For example, the mechanical means may comprise one or more ball bearings located between the inner and outer globes to buoyantly support the inner globe therein. See FIG. 9 and the accompanying relevant text set forth in previous sections of this written description.

Regardless of whether the inner spherical globe is supported within the outer spherical globe via liquid or mechanical means in relation to the tool 670, the outer globe 100 has a diameter of at least about 1.0 millimeter (mm), preferably from about 1.25 millimeters (mm) to about 8.9 millimeters (mm), and more preferably about 4.8 millimeters (mm). The inner globe 140 has a diameter of at least about 0.6 millimeters (mm), preferably from about 0.85 millimeters (mm) to about 8.1 millimeters (mm), and more preferably about 4.0 millimeters (mm). It is understood, however, that inner and outer globe diameters of any dimension may be utilized.

With regard to the information conveyed by the at least one indicator 20 of the tool 670, reference is made again to FIGS. 10-14. While FIGS. 10-14 illustrate the at least one indicator 20 and indicia 170 in relation to the level, the components of the indicator and indicia are equally applicable to the tool 670 of FIG. 22. Thus, referring again to FIG. 10, the inner globe 140 includes the equator 160 defined around its outer periphery that divides the inner globe into equal and symmetrical lower and upper'hemispheres 530 and 540. In the illustrated embodiment, the equator is defined by a line drawn around the globe's outer periphery, with the lower and upper hemisphere having a common color. However, in other embodiments not illustrated herein, the equator of the inner globe is defined by respective contrasting colors (i.e., black and white) of the globe's lower and upper hemispheres. Regardless of how the equator is defined on the inner globe, it is in operable registry relation with the first. indicia 170 to indicate a position of the tool in relation to the adjacent surface or line in question.

Referring again to FIG. 11, the first indicia 170 comprises X and Y axes intersecting one another at 90 degrees, with the outer ends 550 and 560 of the axes located about the outer vessel 94 (i.e., globe 100) of the indicator to define four quadrants 570, 580, 590 and 600. The X and Y axes and quadrants of the first indicia located about the outer globe may thus be located on the bezel of the tool's body 680 of FIG. 22. The quadrants of the first indicia discussed above may optionally include markings 610 and 620 indicating indexed angle and/or pitch values, respectively. The angle values preferably define a range of from about 0 to about 90 degrees of inclination or declination, per quadrant, with about 45 degrees defining the quadrant's mid-point. The pitch values preferably define a range of from about 0 inches of rise per 12 inch run to about 12 inches of rise per 12 inch run, and back to about 0 inches of rise per 12 inch run, per quadrant, with about 12 inches of rise per 12 inch run comprising the quadrant's mid-point.

In other embodiments, the pitch values define a range of from about 0 inches of rise per 12 inch run to about 40 inches of rise per 12 inch run, with about 12 inches of rise per 12 inch run again defining the mid-point. It is understood, however, that other combinations of angle and/or pitch markings may be utilized in other configurations as well. For example, the pitch marking may indicate 0, ⅛, ¼, ⅜ and ½ inch per foot measurements, common to plumbers, or other common measurements as well. For example, the indicia may indicate minute gradations useful to the medical industry or other specialized industries call minute, precise measurements and indications. It is also understood that the pitch values can read in metric denominations as well.

The four quadrants 570, 580, 590 and 600 of the first indicia 170 may optionally define two pairs of quadrants of contrasting color, with each quadrant of a common-color pair located diametrically opposite of one another. The quadrants of a one color may be utilized when determining the degrees of inclination and/or pitch of a given line or surface from the horizontal while quadrants of the contrasting color may be utilized in determining the degrees of inclination and/or pitch of a given line or surface from the vertical.

The first indicia 170, may additionally (FIG. 12) or alternatively (FIG. 13) include a horizontal circumferal equator 630 and a vertical circumferal line 640, preferably located on the front face 110a of the outer globe 100, that intersect one another at 90 degrees. The circumferal equator and vertical circumferal lines define X and Y axes on the front face of the outer globe that, in turn, define horizontal and vertical reference lines. The X and Y axes of the outer globe are respectively aligned with the outer ends 550 and 560 of the X and Y located about the globe.

With regard to the operable registry relation of the inner globe's equator 160 with the first indicia 170, the equator, buoyantly biased in the horizontal position, will lie in registry with the outer ends 550 of the X axis located on the bezel 12 of the tool 670 of FIG. 22 about the outer globe and/or the X axis 630 located on the front face 110a of the outer globe 100 when the tool is positioned perpendicular to the horizontal surface or line in question 180 of FIG. 22. The equator, again buoyantly biased in the horizontal position, will similarly lie in registry with the outer ends 560 of the Y axis located on the bezel 120 about the outer globe and/or the Y axis 640 located on the front face of the outer globe when the body of the tool 670 of FIG. 22 is positioned perpendicular to a vertical surface or line in question 180. Of course, if a given line or surface in question deviates from the horizontal or vertical, the equator will lie in registry with the optional indexed angle and/or pitch values 610 and/or 620 of the quadrants to indicate the degree and/or pitch of the deviation.

Referring again to FIG. 14, a close-up plan view is shown of an alternate embodiment of the indicator 20 and indicia of the tool 670 of FIG. 22, thus illustrating the indicator located at end 700 of the body 680 when the tool is oriented approximately vertically. Again, while FIG. 14 illustrates the indicator in relation to the level, the components of the indicator and indicia are equally applicable to the tool of FIG. 22. For the sake better illustrating the inner globe, bearing 526 has been omitted for clarity. The inner globe 140 is suspended in the upright position within the liquid 150 of the outer globe 100 such that the inner globe's upper hemisphere 540 is facing upwardly and its lower hemisphere 530 is not visible because it is facing downwardly. In this embodiment, the inner globe includes a polar marking 650 concentrically centered within the outer periphery of the upper hemisphere defined by the equator, with the marking in operable registry relation with a second indicia 660 to indicate a vertically-oriented position of the tool 670 in relation to a surface in question 180. Although the polar marking comprises a solid circle within FIG. 14, the polar marking may comprise a cross-hair or other marking as well.

The second indicia 660 preferably comprises a circle and/or cross-hair concentrically located on a top face 110c of the outer globe 100, as viewed from the end 700 of the tool's body 680. The cross-hair may optionally include index lines or gradations to allow a user to determine a percent of grade or elevation. Such index lines or gradations along one or both axes of the crosshair may indicate 0, ⅛, ¼, ⅜ and ½ inch per foot measurements, common to plumbers, or other common measurements as well. The second indicia of the outer globe, when used in operable registry relation with the polar marking 650 of the inner globe 140, allows for an indication and/or measurement of an angle of deviation from vertical in at least two directions of the tool 670. Thus, with regard to the operable registry relation of the inner globe's polar marking with the second indicia, the polar marking will lie in registry with the circle and/or cross-hair located on the rear face of the outer globe when the tool is positioned vertically. Referring again to FIG. 22, in a use of the tool in determining whether the tool is approximately vertical (i.e., plumb), the tool is positioned about vertical and the equator 160 of the inner globe 140 is generally horizontal and aligned in registry with the outer ends 550 of the X axis of the body. In determining whether the tool is approximately horizontal (i.e., level), the tool is positioned about horizontal and the equator 160 of the inner globe 140 is again generally horizontal, but aligned in registry with outer ends 560 of the vertical Y axis of the body. Thus, in both of the foregoing horizontal and vertical determinations, the operable registry relation between the equator of the inner globe and the first indicia is in relation to a positioning of the tool.

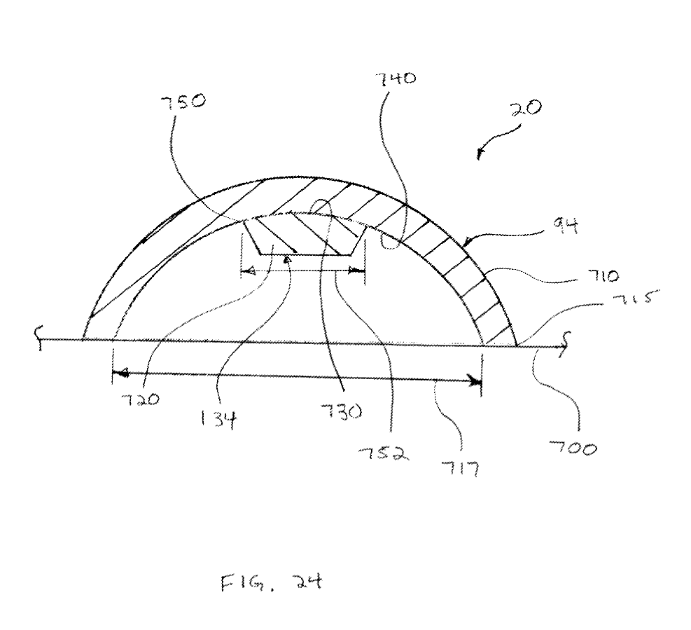

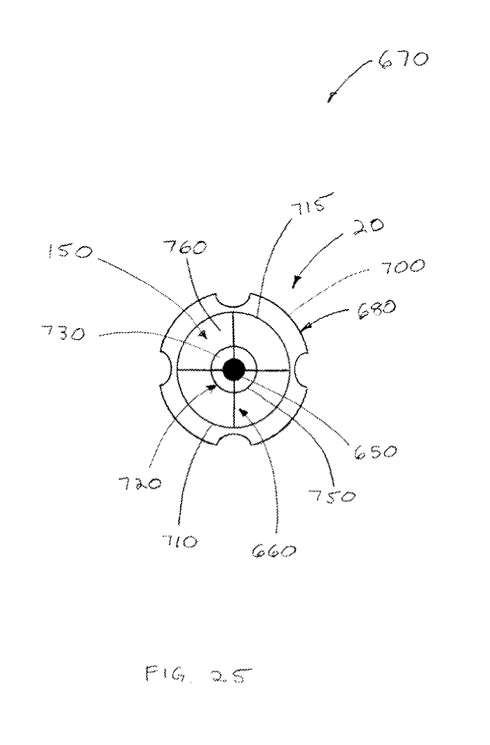

FIGS. 23-25 illustrate alternate embodiments of the indicator 20, with FIG. 23 illustrating the alternate embodiment of the indicator located on the tool 670, FIG. 24 illustrating a detailed section view of the indicator and FIG. 23 and FIG. 25 illustrating a plan view of the illustration of FIG. 22. While FIGS. 23 and 25 do not illustrate a bezel, it is understood that bezel 120 may be utilized to divides the outer vessel 94 into front and rear faces 98a and 98b, and that one or more additional bezels may be utilized as well. For example, two bezels, oriented at 90 degrees to one another, may be utilized to divide the outer vessel into four separate faces or quadrants.

Referring to FIGS. 23, the tool 670 comprises at least one indicator 20 located at one end 700 of the body 680 of the tool. The outer vessel 94 of the indicator comprises a hollow spherical segment 710 defining an outer segment periphery 715. An inner vessel 134 of the at least one indicator is located within the outer vessel 94. The inner vessel, viewable through the outer vessel, also defines a spherical segment 720. It is understood, however, that while the outer vessel of this embodiment preferably comprises a spherical segment, the outer vessel may also comprise a full sphere (i.e., partially embedded in the body of the tool), with the inner vessel comprising the spherical segment.

Referring to FIG. 24, the outer spherical segment 710, in addition to defining an outer segment periphery 715, also defines an outer segment diameter 717. The inner spherical segment 720 defines an outer diameter surface 730 that fits within an inner diameter surface 740 of the outer spherical segment 710. The inner vessel may be buoyantly supported within the outer vessel via a liquid (with optional bearing 526) or via a mechanical means, to be further discussed. The inner spherical segment 720, defined by the inner vessel, further defines an inner segment periphery 750 that is in operable registry relation with a first indicia 170 to indicate a position of the tool in relation to a surface or line in question 180. The inner spherical segment 720, in addition to defining an inner segment periphery 750, also defines an inner segment diameter 752. The inner spherical segment is buoyantly biased within the liquid to maintain the outer circumference in a substantially horizontal position. The configuration of the inner and outer spherical segments 710 and 720 provide the additional advantage of allowing the indicator 20 to be located on smaller tools without sacrificing either the accuracy of the indicator or reducing the indicator's and/or related indicia's readability.

The outer spherical segment 720 has a diameter 717 of at least about 3.3 millimeters (mm), preferably from about 4.1 millimeters (mm) to about 29.4 millimeters (mm), and more preferably about 15.8 millimeters (mm). The inner spherical segment 710 has a diameter 752 of at least about 1.0 millimeters (mm), preferably from about 1.25 millimeters (mm) to about 8.9 millimeters (mm), and more preferably about 4.8 millimeters (mm). It is understood, however, that any dimension may be utilized.

FIG. 25 illustrates a close-up plan view of the alternate embodiment of the indicator 20 of the tool 670 of FIGS. 23 and 24, illustrating the indicator located at end 700 of the body 680 when the tool is oriented approximately vertically. For the sake better illustrating the inner spherical segment 720, bearing 526 has been omitted for clarity. The inner spherical segment 720 is suspended in the upright position within the liquid 150 of the outer spherical segment 710 such that the inner spherical segment's outer diameter surface 730 is facing upwardly and its underside is not visible because it is facing downwardly. In this embodiment, the spherical segment includes a polar marking 650 concentrically centered within the inner spherical segment's periphery 750, with the marking in operable registry relation with the first indicia 170, located on the outer spherical segment, to indicate a vertically-oriented position of the tool 670 in relation to a surface in question 180. Although the polar marking comprises a solid circle within FIG. 25, the polar marking may comprise a cross-hair (i.e., FIG. 23) or other marking as well.

The first indicia 170 preferably comprises a circle and/or cross-hair concentrically located on the outer diameter surface 760 of the outer spherical segment 710, as viewed from the end 700 of the tool's body 680. The cross-hair may optionally include index lines or gradations to allow a user to determine a percent of grade or elevation. Such index lines or gradations along one or both axes of the crosshair may indicate 0, ⅛, ¼, ⅜ and ½ inch per foot measurements, common to plumbers, or other common measurements as well. For example, the indicia may indicate minute gradations useful to the medical industry or other specialized industries call minute, precise measurements and indications. It is also understood that the pitch values can read in metric denominations as well.

The first indicia 170 of the outer spherical segment 710, when used in operable registry relation with the polar marking 650 of the inner spherical segment 720, allows for an indication and/or measurement of an angle of deviation from vertical in at least two directions of the tool 670. Thus, with regard to the operable registry relation of the inner spherical segment's polar marking with the first indicia, the polar marking will lie in registry with the circle and/or cross-hair located on the outer spherical segment when the tool is positioned vertically. The inner segment's periphery 750 of the inner spherical segment 720 may also be used for operable registry relation with the first indicia 170 as well. Referring again to FIG. 23, in a use of the tool in determining whether the tool is approximately vertical (i.e., plumb), the tool is positioned about vertical and the inner segment periphery 750 and/or polar marking of the inner spherical segment 720 is aligned in registry with the with the first indicia 170 of the outer vessel body and/or bezel 120 (if present).

With regard to the embodiments of both FIGS. 22 and 23, the first 170 and/or second indicia 660 may differ in relation to the more than one face of the outer vessel 94. For example, where the outer vessel defines first and second faces 98a and 98b, one face of the vessel may illustrate one type if indicia (i.e., gradient degrees or pitch) while the other face of the outer vessel may define contrasting, indicating colors (i.e., a quadrant or other configuration). Also, the indicia of the vessels and/or bezel may be scaled up or down to improve readability and/or accuracy of the indicator.

With further regard to the embodiments of both FIGS. 22 and 23, the indicators 20 may be optionally oriented to a predetermined measurement or preset angle such that any deviation from the preset angle or measurement reflects an angle amount out from that preset angle. For example, the outer vessel may be oriented to 30 degrees with the first indicia 170 defining “zero” such that any deviation from reference point “zero” will represent a true deviation from 30 degrees. Such a reference point and deviation may be represented by indexed degrees and/or by color-contrasted quadrants as discussed in other portions of this document. Such color-contrasted quadrants may thus be utilized to readily indicate a deviation of an angle amount “into” or “out of” a desired zone, or an indication of a “back-cut” if the tool 670 having the at least one indicator 20 is a saw or other cutting or material-removing device.

In moving or adjusting the at least one indicator 20 to the preset or predetermined position, the indicator may be movably attached to the tool and/or body via a resistance-fit or similar adjustment mechanism. For example, in the embodiment of the indicator 20 illustrated in FIG. 22, the outer vessel 94 mat be connected to the bezel 120 via a resistance-fit such that the outer vessel may be rotatably adjusted or moved in relation thereto to obtain the preset or predetermined angle. Furthermore, in the embodiment of the indicator 20 illustrated in FIG. 23, the outer vessel 94, if comprising a full sphere partially embedded into the body 680, may be connected to the body via a resistance-fit for the same purpose.

Furthermore, the at least one indicator 20 may be fixably or removably located on the, tool 670. With regard to fixably locating the indicator on the tool, the indicator may be unitary with or molded into the housing or body 680 of the tool. The indicator may also be fixably located on the tool via a variety of fixable attachment means, to include adhesives, rivets, welding or other fixable attachment means understood in the art. With regard to removably locating the indicator on the tool, the indicator may be snapped onto the tool itself or the tool's or body, or removably attached to either with a resistance fit. The indicator may also be removably located on the tool and/or body using common fasteners such as nuts and bolts. The indicator may also be slid or snapped onto the tool and/or body via a mating track or guide, as understood in the art, existing between the indicator and tool and/or body.

While this foregoing description and accompanying figures are illustrative of the present invention, other variations in structure and method are possible without departing from the invention's spirit and scope.

We claim:

1. An apparatus comprising:
a tool;
at least one indicator mounted on the tool; and
the at least one indicator comprising an inner vessel buoyantly supported within an outer vessel to indicate a position of the tool.

2. The apparatus of claim 1 wherein the inner and outer vessels comprise spherical globes.

3. The apparatus of claim 1 wherein the inner and outer vessels comprise spherical segments.
